(19) United States
(12) Patent Application Publication
(10) Pub. No.: US 2013/0181701 A1
(43) Pub. Date: Jul. 18, 2013

(54) NONDESTRUCTIVE INSPECTION APPARATUS AND METHOD FOR EVALUATING COLD WORKING EFFECTIVENESS AT FASTENER HOLES

(71) Applicants: Stephen L. L. Galbraith, Butte, MT (US); Lawrence C. Farrar, Butte, MT (US); Chye Hwa Loo, Butte, MT (US); Peter A. Lucon, Butte, MT (US)

(72) Inventors: Stephen L. L. Galbraith, Butte, MT (US); Lawrence C. Farrar, Butte, MT (US); Chye Hwa Loo, Butte, MT (US); Peter A. Lucon, Butte, MT (US)

(21) Appl. No.: 13/261,574

(22) PCT Filed: Jul. 27, 2011
(86) PCT No.: PCT/US11/01326

§ 371 Date: Jan. 25, 2013

(51) Int. Cl. G01N 27/90

(52) U.S. Cl. CPC G01N 27/90
USPC 324/232; 324/244

(57) ABSTRACT

A nondestructive evaluation apparatus and method for qualifying cold worked fastener holes. In an illustrative embodiment, the apparatus comprises a probe and a detector that interprets probe signals. An inductive sensor coil located in the probe uses a magnetic shielding arrangement to focus sensing to a specific zone of cold worked material around a hole in a test specimen. The shielding mitigates edge effects around the hole and measurement dilution away from the hole. A reference coil, located on not cold worked material away from the hole, provides a comparative baseline measurement. Sensor coils are arranged in a novel resonant filter bridge circuit in the probe and connected to the detector. The detector evaluates impedance changes on the probe caused electrical conductivity variations in the test specimen and correlates the changes to cold work quality.

### CROSS REFERENCE TO RELATED APPLICATIONS

This is an international patent application which claims the benefit of U.S. Provisional Patent Application No. 61/400,462, filed Jul. 27, 2010, the disclosure of which patent application, is incorporated by reference as if fully set forth herein.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. N6833506C0059 awarded by the United States Navy.

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

The present invention is in the technical field of nondestructive inspection, evaluation, and testing methods. More particularly, the present invention relates to an electrical conductivity measurement technology using eddy currents to evaluate cold working in metal. An illustrative application of the technology is in the field of qualifying cold worked fastener holes.

A common practice for enhancing the fatigue life of fastener holes in metal airframe structures such as wing planks, spars, and bulkheads is to cold work the material around the fastener hole. The cold working process produces residual compressive stresses around the hole, retarding crack initiation and small crack growth that occur and accumulate during service. Accumulated service cracks are referred to as metal fatigue. When cracks accumulate above a particular level, the metal is no longer considered to have adequate structural properties. As aircrafts age, fatigued parts must be repaired or replaced at scheduled service intervals. It is desirable therefore to enhance the fatigue life and thus extend service intervals using a cold working process. Proper qualification ensuring that the process was performed correctly is required in order to credit extended service life estimates. The present invention provides the necessary qualification of cold worked holes.

One cold working process in the background art is termed, “Split Sleeve Cold Expansion.” It was developed by Fatigue Technology Incorporated, (FTI), Seattle, Wash. The process is performed by pulling a mandrel, or a rod with an enlarged end, through a thin disposable sleeve of material lining the hole. The sleeve material provides interference between the mandrel diameter and the hole diameter. As the mandrel is pulled through the sleeve lined hole, interference expands the hole. After hole expansion, the hole elastically recovers leaving an area of plastic deformation and residual compressive stress around the hole which enhance the hole's fatigue life. The process involves several steps as specified in FTI document 8101D that require tight tolerance control over the individual tooling components, drill, and ream operations in order to control the applied interference between the mandrel and the hole.

The Split Sleeve Cold Expansion process delivers a “predicted” hole expansion which results in a predicted plastically deformed hole and resultant predicted residual compressive stress around the hole. Steps in the expansion process however, can fail to deliver the predicted results for a number of reasons. First, the process involves several intermediate inspection checkpoints that are prone to human error as well as inspection documentation that can be incorrectly filed or misplaced. Second, worn tooling or misapplication of correct tooling sizes will not expand a hole to specification. Third, even when correct tooling is used, a predicted hole expansion can vary from changes in material forming properties that fall within a manufacturers allowable tolerance range for different alloys and tempers. Fourth, the operator, a craftsman, may process a hole slightly different each time which could affect a predicted hole expansion. For these reasons, the cold hole expansion process is used in practice as an “undocumented” fatigue life enhancement operation.

A means to validate cold worked fastener holes, on a per hole basis, will allow the enhanced fatigue life to be “credited” to structural assemblies and therefore extend inspection intervals. Extended inspection intervals reduce operating and maintenance costs. A validation process that is done “post” expansion eliminates the need to trust a predicted result which can be prone to numerous controllable and uncontrollable errors.

Known in the art is Proto Manufacturing, Ypsilanti, Mich., who manufactures a system that can be used for quantifying residual stresses around cold worked fastener holes. The system uses an X-ray diffraction (XRD) technique to measure elastic displacements in a unit crystal within polycrystalline materials and then mathematically convert elastic displacement into residual stress. The system is useful in a laboratory for quantifying stress in test specimens but the technology is generally not portable, rapid, or hand held which are requirements for validating cold worked holes on a per hole basis. Lambda Technologies, Cincinnati, Ohio, also manufacturers XRD equipment provides testing services that can be used on cold worked holes.

Known in the art is Direct Measurements Inc., Atlanta, Ga., who develops and produces strain measurement systems. The systems include disposable surface mounted strain gages used in combination with an optical gage reader. The company purports to have a prototype capable of validating cold worked holes based on measuring the applied amount of expansion.

Known in the art are other research level techniques that have been evaluated for use on cold worked fastener holes such as Photon Induced Positron Annihilation, Meandering Winding Magnetometer and Neutron Diffraction. None of these techniques have found application as commercially available portable inspection tools.

The background art is also characterized by U.S. Pat. Nos. 4,557,033; 4,934,170; 5,127,254; 5,305,627; 5,433,100; 6,230,537; 6,389,865; 6,711,928; and 7,926,319; and U.S. Patent Application No. 2008/0022773; the disclosures of which patents and patent application are incorporated by reference as if fully set forth herein.

### BRIEF SUMMARY OF THE INVENTION

As used herein, the following terms and variations thereof have the meanings given below, unless a different meaning is clearly intended by the context in which such term is used.

“A,” “an” and “the” and similar referents used herein are to be construed to cover both the singular and the plural unless their usage in context indicates otherwise.

“About” means within three percent of a recited parameter or measurement, and preferably within less than one percent of such parameter or measurement.

“Comprise” and variations of the term, such as “comprising” and “comprises,” are not intended to exclude other additives, components, integers or steps.

“Exemplary,” “illustrative,” and “preferred” mean “another.”

A nondestructive evaluation apparatus and method that is used to qualify cold worked fastener holes in aircraft structures using eddy currents is disclosed. Another object of the apparatus is a technology that can identify and/or qualify cold worked metal in structural parts.

In an illustrative embodiment, the invention comprises a probe that comprises one or more inductive sensor coils and a detector circuit that interprets sensor signals. The sensor coil is excited with an alternating current which creates a varying magnetic field that induces eddy currents in the material under test, e.g., cold worked material around a cold worked fastener hole. The induced eddy currents create opposing (secondary) magnetic fields to the magnetic field(s) produced by the sensor coil(s) which in turn change the complex impedance response of the sensor coil(s). The strength of induced eddy currents and their resulting magnetic field strengths are a function of the electrical conductivity of the cold worked material. The electrical conductivity of the material is affected by cold work. This principle allows the induced complex impedance change, between cold worked material and un-cold worked material, to be correlated to the level of cold work present in the material.

Disclosed herein is an illustrative embodiment of a unique sensor probe and several sensor design arrangements for sensing specific areas around cold worked holes where the electrical conductivity has been affected by cold working, while simultaneously excluding other areas around cold worked holes that would otherwise affect the electrical conductivity measurements not due to cold working. An illustrative embodiment of a novel filter bridge circuit is also disclosed which works in combination with the sensor probe to comprise an apparatus that is sensitive to small impedance changes on the sensor.

A benefit of the illustrative embodiments of the nondestructive evaluation apparatus and method disclosed herein is to provide rapid inspection measurements using a technology that is packaged into a small hand held tool that can be operated by a technician with minimum training in nondestructive evaluation methods. This makes it possible to evaluate cold worked holes on a per hole basis so that a service life extension credit—the benefit of cold working—may now be applied to aircraft structures specifically, and to other structures generally, where an evaluation of cold working is desired.

In an illustrative embodiment, the probe is comprised of a sensor coil that centers itself on a cold worked hole in a specimen, is shielded around its inside diameter, and is shielded around its outside diameter. These shields constrain the sensor's magnetic flux to the cold worked region of the specimen between the shields. This region, on a test specimen, affects the sensor's complex impedance response to cold worked material. The inside diameter shield insures that the sensor response is not influenced by edge conditions around the hole such as burrs; the outside diameter shield insures that the sensor response is not diluted by un-cold worked material that lies beyond the cold worked region around the hole.

The sensor coil's shielding and focusing of magnetic flux into a specific cold worked area was discovered to be an important aspect of using eddy currents to inspect cold worked holes because general purpose eddy current conductivity probes, such as a Sigmascope SMP 10 model by Helmut-Fischer, are unduly influenced by edge conditions and sense areas outside the cold worked region. The shielding and flux focus are shown to work on straight hole geometries that accept button head fasteners. Additionally, this shielding also allows for the ability to inspect regions of countersunk hole geometries that accept flat head fasteners.

In a further illustrative embodiment, a reference specimen is used that contains a cold worked hole for which the cold work history is known. The purpose of the reference specimen is to provide a baseline measurement to compare against measurements of material around cold worked holes for which the history is unknown for a pass/fail assessment. The cold worked region around the hole contains both plastic strain and elastic strain simultaneously. The applicants discovered that the electrical conductivity difference between cold worked material and material not cold worked is largely caused by the presence of plastic strain. This finding is surprising because conventional wisdom is that residual stress due to the presence of elastic strain in a material can be measured with eddy currents by correlating an eddy current electrical conductivity measurement to residual stress. However, the applicants found that elastic stress has little or no effect on conductivity measurements made by using commercial eddy current equipment. Plastic strain, however, did exhibit a significant measurable effect. The location and qualitative magnitude of plastic strain in the material around a cold worked hole can be quantified using metallographic microhardness techniques. This finding is important to the design of shielded sensors with inspection footprints that evaluate specific cold worked areas not affected by geometric edge conditions or material that has not been cold worked.

In a further illustrative embodiment, a probe houses two sensor coils that are electrically placed in a bridge configuration. One sensor coil senses cold worked material around a hole; the other sensor coil provides a reference measurement and is positioned in a region outside the area of cold worked material. In this configuration, the complex impedance change on the bridge represents the difference between the sensor impedance on cold worked material and the reference sensor impedance on non-cold worked material. The unique advantage this differential arrangement has over conventional eddy current conductivity testing is that a conductivity variation due to the presence of cold work can be separated from intrinsic conductivity variations in the base material that occur independent of cold working. These intrinsic conductivity variations occur normally in the manufacturing of the base alloy metal and would otherwise add measurement error to a cold work measurement. Electrical conductivity variation ranges for many materials are published in references such as Electronic Components Technology and Materials (ECTM), Canadian Society for Nondestructive Testing (ESNCT), ALSM, and NDT magazine (NDTmag).

In a further illustrative embodiment, the probe houses a signal conditioning circuit board that is situated in close proximity to the sensor coils. The signal conditioning circuit board mitigates signal loss and environmental noise that can occur. In this embodiment, the signal conditioning circuit board comprises a resonant filter bridge in a full bridge arrangement with a “sense” sensor in one leg of the bridge and a “reference” sensor in another leg of the bridge. Full impedance bridge configurations such as this are used in differential eddy current measurement systems and are well known in the art; however, a novel aspect of the bridge configuration disclosed here is that two legs of the bridge, the sense leg and the reference leg, comprise additional passive reactive elements and buffer amplifiers that comprise isolated resonant systems.

In an illustrative embodiment, the passive reactive elements located in each leg of the resonant filter bridge are capacitors whose values are chosen to work in combination with reactive sensor coils which are inductors. This combination of passive reactive elements is tuned to operate at, or near a resonant frequency, which coincides with a selected eddy current inspection frequency, e.g., 50 kHz. The advantage of operating a bridge circuit with legs containing reactive components and sensors near resonance is that a small impedance change on a sensor, caused by small electrical conductivity changes from a material that has been cold worked, produces large phase and amplitude shifts in frequency which can be easily measured using known circuit techniques. Another advantage of using the additional capacitive reactive components in the bridge circuit is that the component values may be selected to tune the resonant frequency so that the sensor becomes more sensitive to electrical conductivity variation and less sensitive to liftoff.

Liftoff is an incomplete coupling between an eddy current sensor and test part. Liftoff is caused by the presence of a coating such as paint, probe wobble, or out of plane distortions in the material surrounding a cold worked hole. A low inspection input signal frequency, e.g., in the kilohertz (kHz) range, mitigates some of the liftoff effect but the remainder must be compensated mechanically, electrically, algorithmically, or a combination thereof. Combinations are preferred as is disclosed herein.

In an illustrative embodiment, buffer amplifiers located in each leg of the resonant filter bridge provide three beneficial attributes. The first is to obtain electrical isolation between sensing legs. The second is to amplify current to excite the sensors. The third is to provide low output impedance to an inspection frequency signal generator that is part of the apparatus. Low output impedance increases the quality factor, Q, of each leg. A high Q circuit displays a peaked frequency response and in this application, a stronger resonant response.

In an illustrative embodiment, the resonant filter bridge comprises two additional dummy coils imitated resistor and inductor pairs. The dummy coils may be used for drift compensation by providing a reference load. In this embodiment, the resistors and inductors are low thermal drift components. A pair of analog switches is preferably added to the resonant filter bridge for the purpose of switching the test and reference coils to the two dummy coils. Changes in drift for gain and offset values in the measurement circuit can occur as circuit components heat while the apparatus warms up, especially amplifier components. The warm up drift in the system can be reduced by normalizing measurements made by the test and reference coil to measurements made on the dummy coils.

In an illustrative embodiment, the invention is a nondestructive evaluation method for determining cold working effectiveness of a test specimen, said nondestructive evaluation method comprising: imposing a changing primary magnetic field on a cold worked portion of a first reference specimen having a first cold worked value that is known, substantially shielding the remaining portion of said first reference specimen from said changing primary magnetic field, and electromagnetically inducing a first eddy current in said cold worked portion with a coil to cause said reference specimen to produce a first secondary magnetic field; measuring a first response in said coil to said first secondary magnetic field to produce a first reference signal having a first reference value; imposing said changing primary magnetic field on a not cold worked portion of said first reference specimen or a second reference specimen having a second cold worked value that is known, substantially shielding the remaining part of said first reference specimen or a second reference specimen from said changing primary magnetic field, and electromagnetically inducing a second eddy current in said not cold worked portion with said coil to cause said first reference specimen or said second reference specimen to produce a second secondary magnetic field; measuring a second response in said coil to said second secondary magnetic field to produce a second reference signal having a second reference value; using said first reference values and said second reference value to establish a measurement range of cold working effectiveness and to correlate each of said reference values with a cold work effectiveness value, and placing said measurement range and said correlation in a memory; imposing said changing primary magnetic field on a test portion of the test specimen having an unknown cold worked value, substantially shielding the remainder of said test specimen from said changing primary magnetic field, and electromagnetically inducing a test eddy current in said test portion with said coil to cause the test specimen to produce a test secondary magnetic field; measuring a test response in said coil to said test secondary magnetic field to produce a test signal having a test value; using said measurement range and said correlation in processing said test value to determine a cold work effectiveness value for said test portion of the test specimen.

In another illustrative embodiment, the invention is a nondestructive evaluation method for determining cold working effectiveness of a cold worked portion of a test specimen, said nondestructive evaluation method comprising: generating an eddy current in the cold worked portion with a changing magnetic field produced by an alternating current in a coil to produce a secondary magnetic field, while shielding the remainder of the test specimen from said changing magnetic field; measuring test changes in the resistance and the inductive reactance of said coil caused by said secondary magnet field; and comparing said test changes to reference changes measured on a reference specimen and determining the cold working effectiveness of the cold worked portion of the test specimen.

In a further illustrative embodiment, the invention is a nondestructive evaluation method for determining cold working effectiveness of a test specimen, said nondestructive evaluation method comprising: a step for imposing a changing primary magnetic field on a cold worked portion of a first reference specimen having a first cold worked value that is known, substantially shielding the remaining portion of said first reference specimen from said changing primary magnetic field, and electromagnetically inducing a first eddy current in said cold worked portion with a coil to cause said reference specimen to produce a first secondary magnetic field; a step for measuring a first response in said coil to said first secondary magnetic field to produce a first reference signal having a first reference value; a step for imposing said changing primary magnetic field on a not cold worked portion of said first reference specimen or a second reference specimen having a second cold worked value that is known, substantially shielding the remaining part of said first reference specimen or a second reference specimen from said changing primary magnetic field, and electromagnetically inducing a second eddy current in said not cold worked portion with said coil to cause said first reference specimen or said second reference specimen to produce a second secondary magnetic field; a step for measuring a second response in said coil to said second secondary magnetic field to produce a second reference signal having a second reference value; a step for using said first reference values and said second reference value to establish a measurement range of cold working effectiveness and to correlate each of said reference values with a cold work effectiveness value, and placing said measurement range and said correlation in a memory; a step for imposing said changing primary magnetic field on a test portion of the test specimen having an unknown cold worked value, substantially shielding the remainder of said test specimen from said changing primary magnetic field, and electromagnetically inducing a test eddy current in said test portion with said coil to cause the test specimen to produce a test secondary magnetic field; a step for measuring a test response in said coil to said test secondary magnetic field to produce a test signal having a test value; a step for using said measurement range and said correlation in processing said test value to determine a cold work effectiveness value for said test portion of the test specimen.

In yet another illustrative embodiment, the invention is a nondestructive evaluation method for determining cold working effectiveness of a cold worked portion of a test specimen, said nondestructive evaluation method comprising: a step for generating an eddy current in said cold worked portion with changing magnetic field produced by an alternating current in a coil to produce a secondary magnetic field, while shielding the remainder of the test specimen from said changing magnetic field; a step for measuring test changes in the resistance and the inductive reactance of said coil caused by said secondary magnet field; and a step for comparing said test changes to reference changes measured on a reference specimen and determining the cold working effectiveness of the cold worked portion of the test specimen.

In another illustrative embodiment, the invention is a nondestructive evaluation apparatus for determining cold working effectiveness of a test specimen, said nondestructive evaluation apparatus comprising: means for imposing a changing primary magnetic field on a cold worked portion of a first reference specimen having a first cold worked value that is known, substantially shielding the remaining portion of said first reference specimen from said changing primary magnetic field, and electromagnetically inducing a first eddy current in said cold worked portion with a coil to cause said reference specimen to produce a first secondary magnetic field; means for measuring a first response in said coil to said first secondary magnetic field to produce a first reference signal having a first reference value; means for imposing said changing primary magnetic field on a not cold worked portion of said first reference specimen or a second reference specimen having a second cold worked value that is known, substantially shielding the remaining part of said first reference specimen or a second reference specimen from said changing primary magnetic field, and electromagnetically inducing a second eddy current in said not cold worked portion with said coil to cause said first reference specimen or said second reference specimen to produce a second secondary magnetic field; means for measuring a second response in said coil to said second secondary magnetic field to produce a second reference signal having a second reference value; means for using said first reference values and said second reference value to establish a measurement range of cold working effectiveness and to correlate each of said reference values with a cold work effectiveness value, and placing said measurement range and said correlation in a memory; means for imposing said changing primary magnetic field on a test portion of the test specimen having an unknown cold worked value, substantially shielding the remainder of said test specimen from said changing primary magnetic field, and electromagnetically inducing a test eddy current in said test portion with said coil to cause the test specimen to produce a test secondary magnetic field; means for measuring a test response in said coil to said test secondary magnetic field to produce a test signal having a test value; means for using said measurement range and said correlation in processing said test value to determine a cold work effectiveness value for said test portion of the test specimen.

In a further illustrative embodiment, the invention is a nondestructive evaluation apparatus for determining cold working effectiveness of a cold worked portion of a test specimen, said nondestructive evaluation apparatus comprising: means for generating an eddy current in said cold worked portion with changing magnetic field produced by an alternating current in a coil to produce a secondary magnetic field, while shielding the remainder of the test specimen from said changing magnetic field; means for measuring test changes in the resistance and the inductive reactance of said coil caused by said secondary magnet field; and means for comparing said test changes to reference changes measured on a reference specimen and determining the cold working effectiveness of the cold worked portion of the test specimen.

In another illustrative embodiment, the invention is a analyzer for a workpiece comprising a portion situated around a cold worked hole and a remaining portion, said analyzer comprising: a probe comprising a first sensing element inductive coil for producing a first changing magnetic field that induces a first eddy current in the portion situated around the cold worked hole and for producing a first output signal, a centering pin or machine element for centering said first sensing element over the portion situated around the cold worked hole, a first inner magnetic shield that is disposed adjacent to said centering pin or machine element and between said centering pin or machine element and said sensing element inductive coil that effectively shields the edge of the hole from said changing magnetic field, and a first outer magnetic shield that is disposed adjacent to said first sensing element inductive coil and said first inner magnetic shield that effectively shields the remaining portion of the workpiece from said first changing magnetic field, a second sensing element inductive coil for producing a second changing magnetic field that induces a second eddy current in the remaining portion and for producing a second output signal, a second inner magnetic shield that is disposed adjacent to said second sensing element inductive coil, a second outer magnetic shield that is disposed adjacent to said second sensing element inductive coil and said second inner magnetic shield that effectively shields a portion of the workpiece away the cold worked hole from said second changing magnetic field, and a signal conditioning circuit board that is operative to send input signals to said sensing element inductive coils and to receive said output signals from said sensing element inductive coils, a signal conditioning circuit board that is operative to send an input signal to said sensing element inductive coil and to receive said output signal from said sensing element inductive coil; a detector comprising a main detector circuit board that comprises a sine wave generator, a phase correction phase shifter, a ninety degrees phase shifter, a first lock-in amplifier, a data processing subsystem, a graphic user interface, a second lock-in amplifier and a low pass filter; and an interconnect cable that connects said probe to said detector and supports two-way communication between said detector and said probe; wherein said sine wave generator is operative to input a sine wave signal to said signal conditioning circuit board and to said phase correction phase shifter; wherein said phase correction phase shifter is operative to input a phase corrected signal to said ninety degrees phase shifter and to said second lock-in amplifier; wherein said ninety degrees phase shifter is operative to input a phase shifted signal to said first lock-in amplifier; wherein said first lock-in amplifier is operative to input a first amplified signal to said data processing subsystem, to said second lock-in amplifier, and to said low pass filter; wherein said low pass filter is operative to receive an output signal from said signal conditioning circuit board; wherein said second lock-in amplifier is operative to input a second amplified signal to said data processing subsystem; and said data processing subsystem is operative to process said amplified signals and to send and receive interface signals from said graphic user interface.

In another illustrative embodiment, the invention is a nondestructive evaluation kit for determining whether a cold worked hole in an electrically conductive specimen is cold worked to an acceptable level, said nondestructive evaluation kit comprising: an enclosed sensor probe that is operative to generate an eddy current in a portion of the electrically conductive specimen around the cold worked hole and not in the remainder of the electrically conductive specimen, to evaluate said portion for cold work effectiveness, and to produce an output signal; an enclosed detector that is operative to send an input signal to said enclosed sensor probe, to process the output signal from said sensor probe, to produce a result, and to communicate said result with a user; an interconnect cable that is operative to transfer two way communications between said enclosed sensor probe and said enclosed detector; and a reference specimen having a known cold work effectiveness that is operative to cause said enclosed sensor probe to produce a reference output signal when said reference specimen is evaluated by said enclosed sensor probe. In another embodiment, the electrically conductive specimen is comprised of aluminum, mild steel, steel, titanium, or one of their alloys, or a nickel based alloy. In another embodiment, said reference specimen has a hole that has been drilled, reamed, cold expanded, and post reamed, and said reference specimen comprises: an annular cold worked zone around said hole that contains plastic strain identified using metallographic microhardness and elastic strain identified using X-ray diffraction, said annular cold worked zone having an inner boundary and an outer boundary; and a zone outside of said annular cold worked zone that does not have cold work properties. In another embodiment, said portion is an annular zone and said enclosed sensor probe comprises: a sensing element in the form of an inductive coil that is operative to generate primary alternating magnetic fields in said annular zone around a cold worked hole wherein said alternating magnetic fields induce alternating eddy currents in the electrically conductive substrate, wherein said alternating eddy currents in the electrically conductive substrate are operative to create secondary alternating magnetic fields which oppose the alternating magnetic fields being generated by said sensing element, wherein interaction among the primary and secondary alternating magnetic fields is operative to affect a complex impedance of said sensing element in a way that indicates the cold work effectiveness in said annular zone; a centering pin or machine element that is operative to locate said sensing element concentric to the cold worked hole; a burr relief area around said centering pin or machine element that is operative to allow said enclosed sensor probe to rest flat on a surface of said electrically conductive specimen around the cold worked hole; an inner magnetic shield that is disposed around said centering pin or machine element that is operative to prevent said complex impedance response of the eddy current sensor from being influenced by the presence of a burr, the size of the burr, or an edge effect around the cold worked hole; and an outer magnetic shield that is disposed around said sensing element that is operative to prevent said complex impedance response of the eddy current sensor from being influenced by an eddy current in material outside the cold worked area, or an adjacent edge effect from an adjacent hole that is disposed adjacent the cold worked hole. In another embodiment, said magnetic shields comprise a material of construction having a magnetic permeability property which is operative to provide a low magnetic reluctance (lower than the magnetic reluctance of the specimen) path for shaping said primary alternating magnetic fields. In another embodiment, said magnetic shields comprise a magnetic material that is formable or machinable. In another embodiment, said magnetic shields comprise a mu-metal alloy or a ferrous material.

In another embodiment, said magnetic shields comprise a magnetic material that is castable into an annular shape. In another embodiment, said magnetic shields comprise a ferrite material. In another embodiment, said enclosed sensor probe is configured so as to be capable of evaluating cold worked hole diameters ranging from ⅛ inch to 1 inch. In another embodiment, said enclosed sensor probe is configured so as to be capable of evaluating a straight hole used with a button head fastener. In another embodiment, said enclosed sensor probe is configured so as to be capable of evaluating a countersunk hole used with a flat head fastener.

In another illustrative embodiment, the invention is an eddy current sensing technique for evaluating a material having a test not cold worked zone and a test hole that is surrounded by a test annular cold worked zone that has an unknown cold working effectiveness, said technique comprising: imposing an alternating current on a probe having two sensor coils to produce two changing magnetic fields; measuring a first reference electrical conductivity of a reference annular cold worked zone around a reference hole in a reference specimen having a known cold working effectiveness and measuring a second reference electrical conductivity of a reference not cold worked zone in a reference specimen having a known not cold working effectiveness to produce a reference differential result, said known cold working effectiveness indicating that said reference annular cold worked zone has experienced a desired amount of plastic strain; measuring a first test electrical conductivity of the test annular cold worked zone and measuring a second test electrical conductivity in the test not cold worked test zone to produce a test differential result; and comparing the test differential result to the reference differential result and producing a determination of whether and the extent to which the test hole has experienced said desired amount of plastic strain; thereby assuring that said determination is not influenced by ambient temperature variation during the measuring steps, by the metal alloy composition of the material, by heat treatment of the material, by artificial aging of the material, and by rolling of the material. In another embodiment, the eddy current sensing technique further comprises: imposing an alternating current on said probe having said two sensor coils comprising an evaluation sensor and a reference sensor, said two sensor coils being arranged in a side by side pattern wherein said evaluation sensor is postionable on the test annular cold worked zone while said reference sensor is positioned on the test not cold worked zone and said evaluation sensor is positionable on said reference annular cold worked zone while said reference sensor is positioned on said reference not cold worked zone.

In another embodiment, the eddy current sensing technique further comprises: imposing an alternating current on a probe having a plurality of sensor coils comprising an evaluation sensor and a reference sensor wherein said plurality of sensor coils is arranged in a concentric pattern wherein said evaluation sensor is positionable on the test annular cold worked zone while a reference sensor is positioned on an annular test not cold worked zone and said evaluation sensor is positionable on said reference annular cold worked zone while said reference sensor is positioned on said reference not cold worked zone. In another embodiment, said alternating current is in a range between about 10 kiloHertz (kHz) and about 100 kHz, thereby producing increasing material penetration without being influenced by the thickness of the material.

In yet another illustrative embodiment, the invention is an eddy current sensing technique for evaluating a material having a test not cold worked zone and a test hole that is surrounded by a test annular cold worked zone that has an unknown cold working effectiveness, said technique comprising: imposing an alternating current on a calibrated probe having a plurality of sensor coils comprising an exciting sensor, an inner evaluation sensor and a outer reference sensor that are disposed in a concentric exciting-excited arrangement wherein said inner evaluation sensor is located on the test annual cold worked zone, said outer reference sensor is located on a reference annular zone, and said exciting sensor is located between said inner evaluation sensor and said outer reference sensor; measuring a reference electrical conductivity of said reference annular zone to produce a reference signal; measuring a test electrical conductivity of the test annular zone to produce a test signal; and comparing said test signal to said reference signal and producing a determination of whether and the extent to which the test hole has experienced said desired amount of plastic strain.

In yet another illustrative embodiment, the invention is a nondestructive evaluation apparatus for determining whether a cold worked hole in an electrically conductive specimen is cold worked to an acceptable level, said nondestructive evaluation apparatus comprising: a probe comprising an eddy current sensor that is operative to generate an eddy current in a portion of the electrically conductive specimen around the cold worked hole and not in the remainder of the electrically conductive specimen, to evaluate said portion for cold work effectiveness, and to produce an output signal; and a detector that is operative to send an input signal to said probe, to process the output signal from said probe, to produce a result, and to communicate said result to a user. In another embodiment, said probe further comprises an electronic signal conditioning circuit that comprises a resonant filter bridge in a full bridge arrangement comprising: two passive RLC filters, wherein the resonant response of the resonant filter bridge is operative to maximize the amplitude response of said eddy current sensor and to minimize the response of said eddy current sensor to incomplete inductive coupling between said eddy current sensor and said electrically conductive specimen, and wherein said resonant filter bridge is operative to maximize the phase shifting response of said eddy current sensor to small variations of sensor probe impedance; and two buffer amplifiers, one in each half bridge of said resonant filter bridge, which provide an input impedance to an input signal from a frequency generator located on a separate circuit board and connected to said resonant filter bridge via an interconnect cable, signal isolation between each half bridge, an amplified current for said eddy current sensor, and an output impedance that increases the Q-factor of said RLC filter and increases the sensitivity of said eddy current sensor; and an instrument amplifier that is operative to amplify amplitude and phase shift differences between each half bridge and to combine an amplified output from each half bridge into a single differential output signal; thereby preserving the ability the apparatus to evaluate complex impedance data, real and imaginary. In another embodiment, said detector further comprises: a resonant filter bridge circuit that comprises an eddy current sensor and an RCL filter operating near resonance and is operative to provide multiple stages of amplification of changes in sensor probe impedance and to produce amplified phase shifts in a bridge output signal, thereby taking advantage of the phase response of said RCL filter operating near resonance to amplify small inductance changes from said eddy current sensor; an instrument amplifier that is operative to convert a phase shift to an amplitude; a synchronous detector circuit with selective filters that are operative to tune out unwanted noise; or a lock-in amplifier circuit that comprises a phase shifter that is operative to create a reference signal from a source frequency generator output, and lock-in amplifiers that are operative to extract reference signals and sensed signals from background noise. In another embodiment, said eddy current sensor further comprises an evaluation sensor and a reference sensor said detector further comprises: a plurality of dummy coils, and a resonant filter bridge circuit in a full bridge arrangement that includes a coil switching configuration that is operative to allow switching among said dummy coils that are temperature stable and provide a reference to said evaluation coil sensor and to said reference sensor, wherein said dummy coils are switched in and out of of said resonant filter bridge circuit to provide comparative data between a test measurement and a reference measurement; thereby providing reference values during warm up of the apparatus, reference values during operation of the apparatus, and means for compensating for thermal drift in apparatus components.

In yet another embodiment, the invention is any one or more of the components of the analyzer kit, for example, the detector, the probe, or the reference specimens. In one such embodiment, any of the probes disclosed herein is used with a background art or otherwise commercially-available eddy current instrument that includes a detector that is compatible with the probe. In an alternative embodiment, separate power sources are provided for the detector and the probe and the detector and the probe communicate wirelessly.

Further aspects of the invention will become apparent from consideration of the drawings and the ensuing description of exemplary embodiments of the invention. A person skilled in the art will realize that other embodiments of the invention are possible and that the details of the invention can be modified in a number of respects, all without departing from the concept. Thus, the following drawings and description are to be regarded as illustrative in nature and not restrictive.

### BRIEF DESCRIPTION OF THE SEVERAL VIEWS OF THE DRAWING

The features of the invention will be better understood by reference to the accompanying drawings which illustrate exemplary embodiments of the invention. In the drawings:

FIG. 1 is an illustration of a functional apparatus or kit for carrying out an illustrative embodiment of the invention including a probe, an interconnect cable, a detector, and reference specimens having cold worked holes.

FIG. 2A is a schematic diagram of a specimen having cold worked hole that illustrates a cold worked zone.

FIG. 2B is a plot of residual stress as a function of distance away from the edge of a cold worked hole and a not-cold worked hole that was obtained using X-ray diffraction.

FIG. 2C is a plot of micro hardness as a function of distance away from the edge of a cold worked hole and a not-cold worked hole that was obtained using metallography.

FIG. 3A is a schematic cross sectional view of a sensor on a cold worked hole that illustrates an inner shield, an outer shield, and a magnetic field generating eddy currents in a cold worked zone.

FIGS. 3B, 3C, and 3D are cross-sectional views that depict preferred locations for sensing the presence of cold work for surface measurements on straight and countersunk holes, and for in-hole measurements for straight and countersunk holes.

FIG. 4A is a plot of electrical conductivity as a function of elastic and plastic strain on an aluminum tensile test specimen that was taken using an eddy current meter.

FIG. 4B is a plot of electrical conductivity as a function of burr height on machined aluminum test specimen that was taken using an eddy current meter.

FIGS. 5A, 5B, and 5C are schematic line drawings of sensor arrangements where a sense and reference sensor may be used to create a differential measurement.

FIG. 6 is a cross sectional view of a probe containing two sensor coils, a resonant bridge circuit, and a housing in accordance with an illustrative embodiment of the invention.

FIG. 7 is a schematic drawing of a signal conditioning circuit that contains a resonant filter bridge with eddy current sensors and an instrument amplifier detector section in accordance with an illustrative embodiment of the invention.

FIG. 8 is a schematic drawing of a switch-mode bridge circuit in accordance with an illustrative embodiment of the invention that is a modification of the circuit illustrated in FIG. 7. Analog switches and dummy coils are added in accordance with an illustrative embodiment of the invention.

FIG. 9 is a schematic drawing of a sensor detector system that comprises a main detector circuit board and signal conditioning circuit for generating and evaluating signals to and from a resonant bridge circuit in accordance with an illustrative embodiment of the invention;

FIG. 10 is a plot of scaled voltage readings taken with a prototype of an embodiment of the invention that shows a difference between cold worked holes and not-cold worked holes;

The following reference numerals are used to indicate the parts and environment of the invention on the drawings:
1 cold worked hole analyzer, analyzer, kit, nondestructive evaluation apparatus
2 detector
3 probe
4 interconnect cable
5 reference specimen
6 inner cold work boundary
7 outer cold work boundary
8 zone with no cold work, not cold worked zone
9 centering pin, machine element
10 burr relief area
11 burr around edge of cold worked hole, burr
12 inner magnetic shield
13 sensing element inductive coil, sensor coil, coil
14 outer magnetic shield
15 alternating magnetic fields and eddy currents
16 inductive eddy current sensor assembly, sensor coil assembly
17 conductivity response to stress, elastic strain response
18 conductivity response to permanent deformation, plastic strain response
19 evaluation sensor
20 reference sensor
21 exciting sensor
22 side-by-side sensor arrangement
23 concentric sensor arrangement
24 concentric exciting-excited arrangement
25 probe housing, housing
26 signal conditioning circuit board, resonant bridge circuit
27 resonant filter bridge circuit, resonant filter bridge
28 left leg of the resonant filter bridge, left leg
29 right leg of the resonant filter bridge, right leg
30 buffer amplifiers
31 instrumentation amplifier
32 evaluation sensor coil elements, evaluation coil elements
33 reference sensor coil elements, reference coil elements
34 capacitors
35 main detector circuit board, detector circuit
36 sensor detector system
37 sine wave function generator, source frequency generator
38 primary lock-in amplifier circuit
39 secondary lock-in amplifier circuit
40 phase correction phase shifter
41 lock-in amplifier chipset A
42 lock-in amplifier chipset B
43 lowpass filters
44 switch-mode signal conditioning circuit board, switch-mode circuit
45 ninety degrees phase shifter
46 data processing subsystem
47 graphic user interface (GUI)
48 measurement on cold worked hole, cold worked hole reading
49 measurement on non-cold worked hole, not cold worked hole reading
50 non-cold worked hole stress measurements
51 cold worked hole stress measurements
52 cold worked boundary
53 non-cold worked hole microhardness measurements
54 cold worked hole microhardness measurements
55 conductivity response to burrs
56 conductivity response to no burrs
57 straight hole surface inspection specimen
58 countersunk hole surface inspection specimen
59 countersunk or straight hole, in-hole specimen
61 first dummy coil
62 second dummy coil
63 first analog switch
64 second analog switch
65 cold worked hole
67 cold worked zone, cold worked region
69 first control line
71 second control line

### DETAILED DESCRIPTION OF THE INVENTION

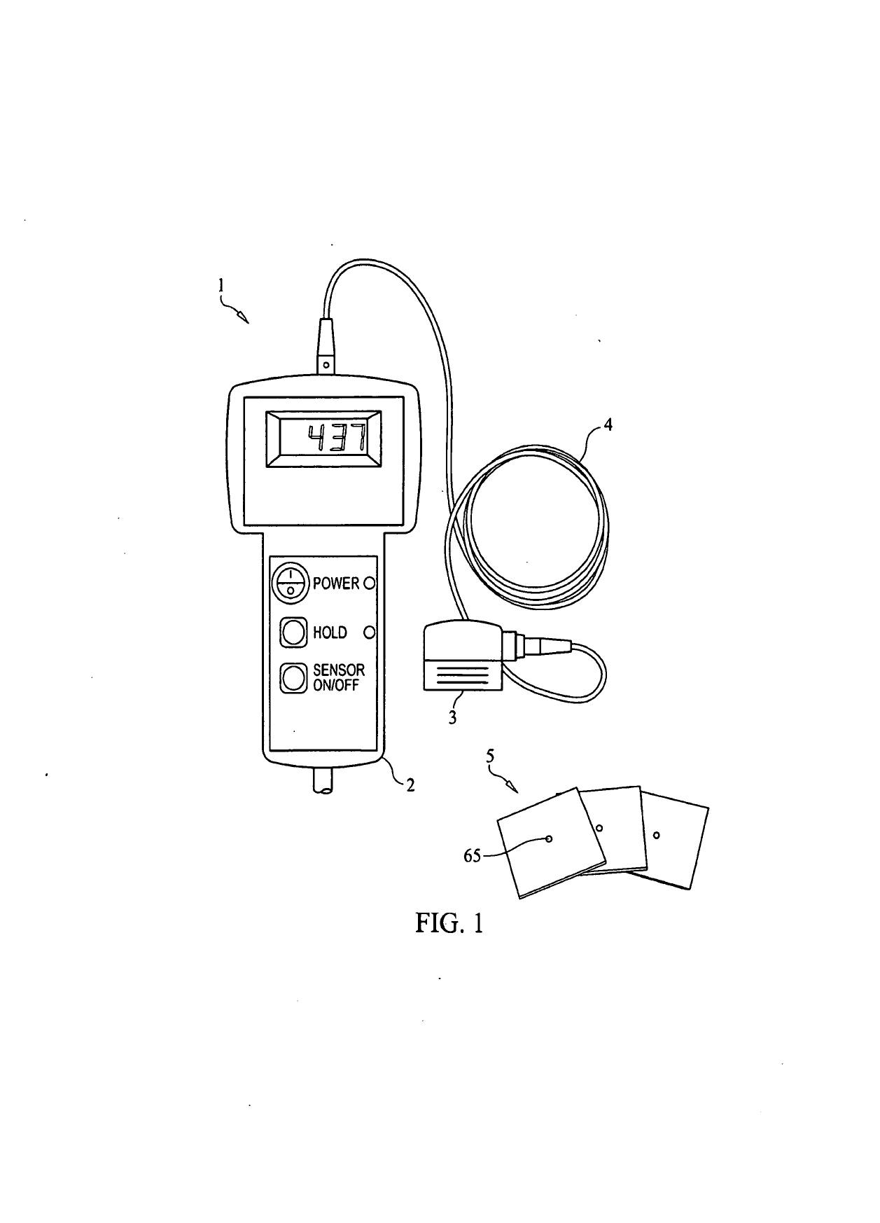

Referring to FIG. 1, an illustrative embodiment of a cold worked hole analyzer kit 1 is presented. In this embodiment, the cold worked hole analyzer 1 includes detector 2, probe 3, interconnect cable 4 for connecting detector 2 to probe 3, and reference specimens 5. Reference specimens 5 with not cold worked holes and cold worked holes 5 are used to provide baseline electrical measurements taken with the cold worked hole analyzer 1.

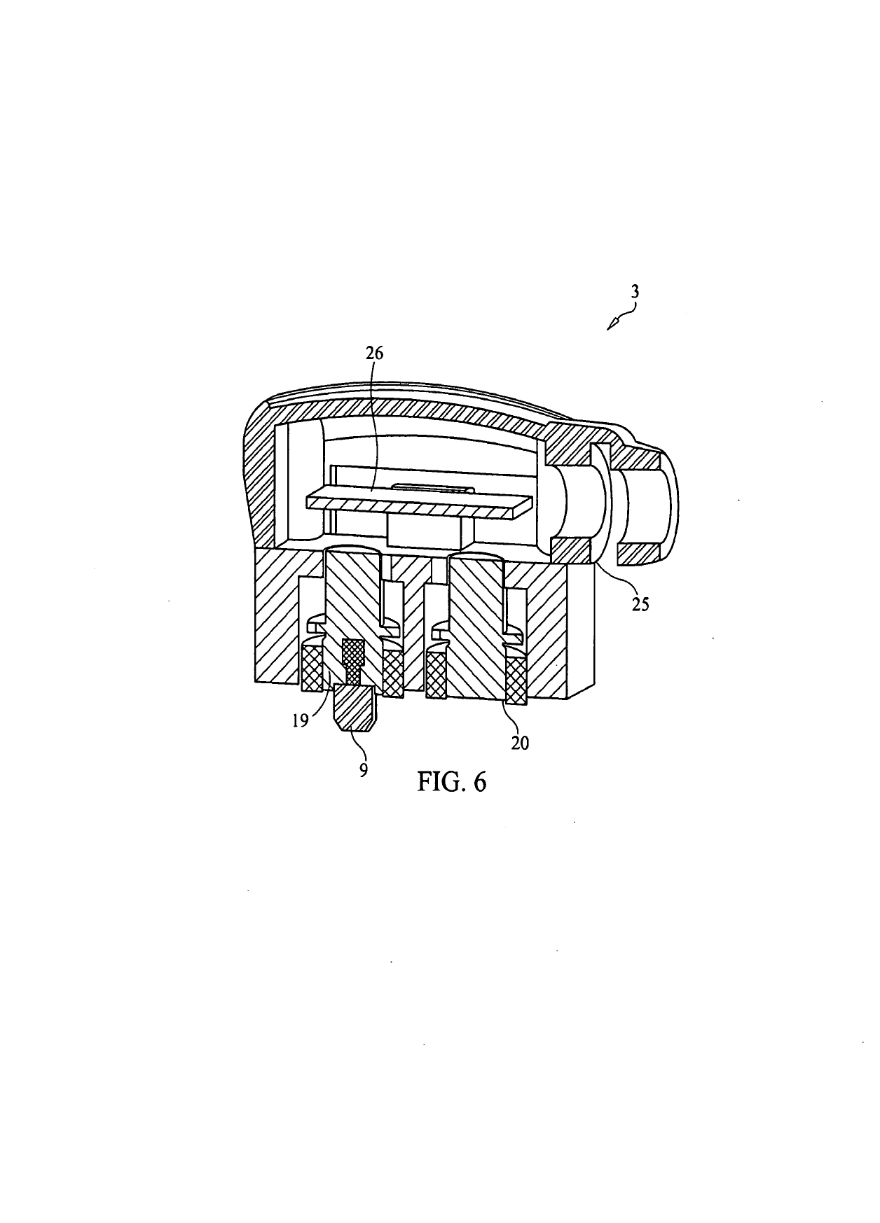

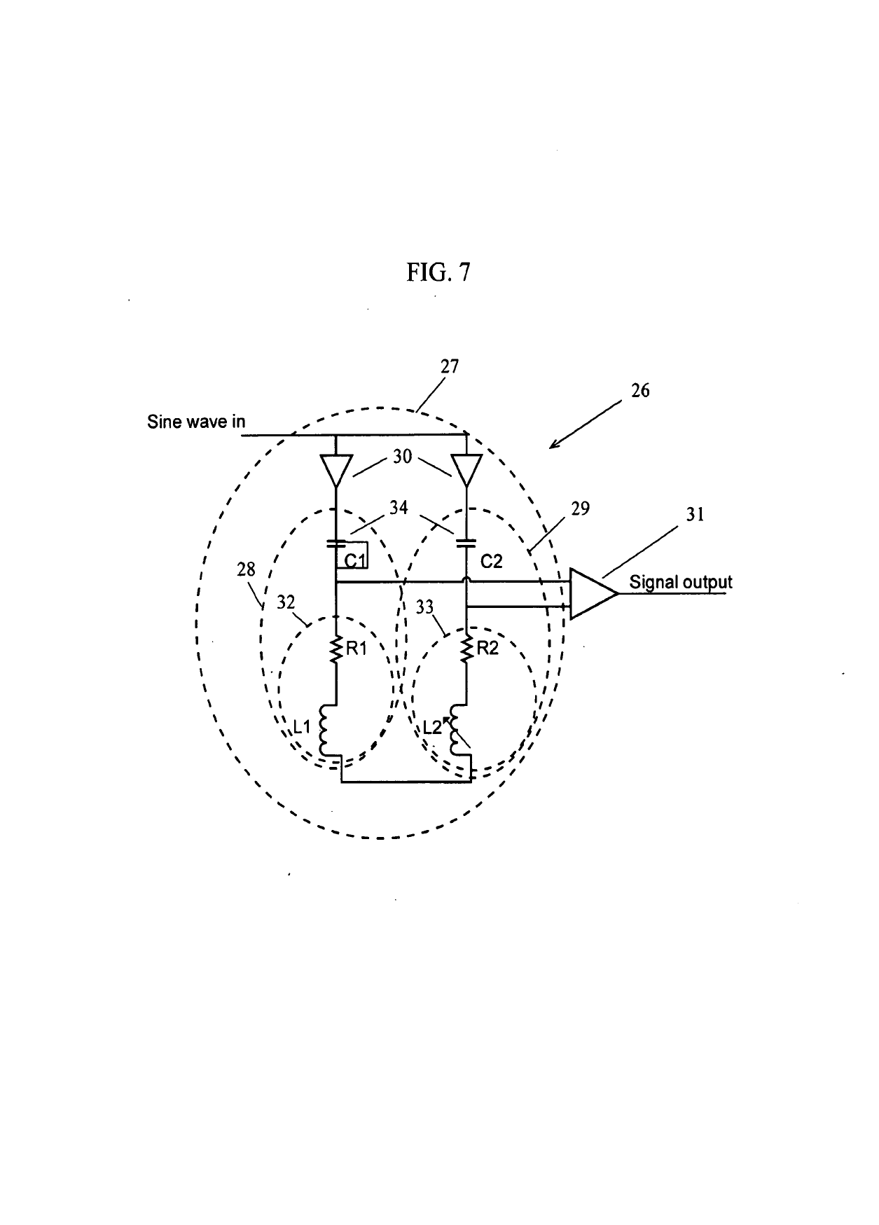

Referring to FIG. 6, in this embodiment, probe 3 comprises two sensing coils, evaluation coil 19, reference coil 20, and signal conditioning board 26. Both sensing coils 19, 20 are placed in contact with a reference specimen at the same time. Then (or before), both sensing coils 19, 20 are placed in contact with a workpiece to be tested at the same time. Evaluation sensor 19 and reference sensor 20 are in resonant filter bridge circuit 27 (see FIG. 7 in which they are represented by evaluation sensor coil components 32 and reference sensor coil components 33, respectively).

In its operation, a technician takes electrical measurements on the reference specimens and electrical measurements on holes in the workpiece that are to be qualified. The difference between measurements is an indication of how much the hole to be qualified deviates from the baseline reference specimen. An allowable difference is pre-established and the cold worked analyzer can then provide a go no-go status. Alternatively, the allowable difference may be established at a later date for evaluation. In this case, the electrical measurements are simply stored in memory and written to a data file.

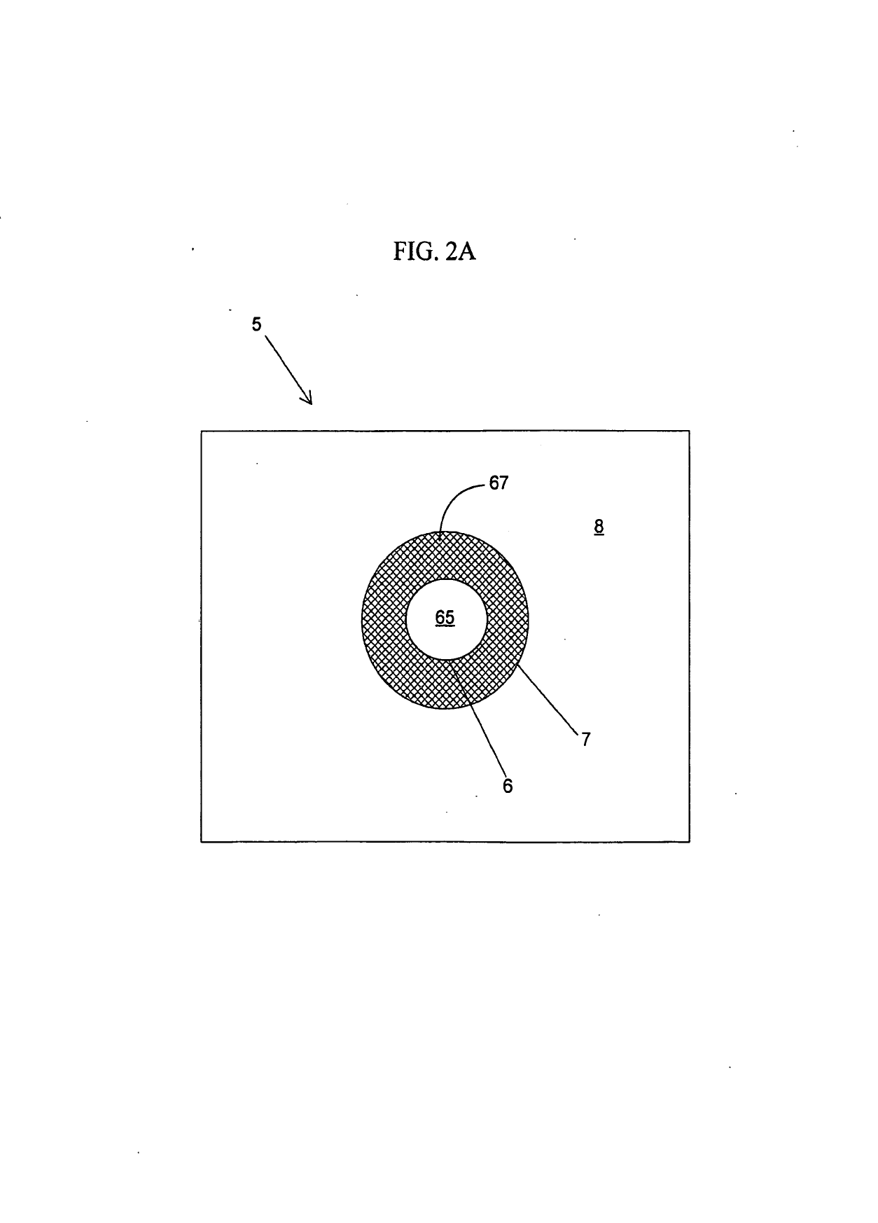

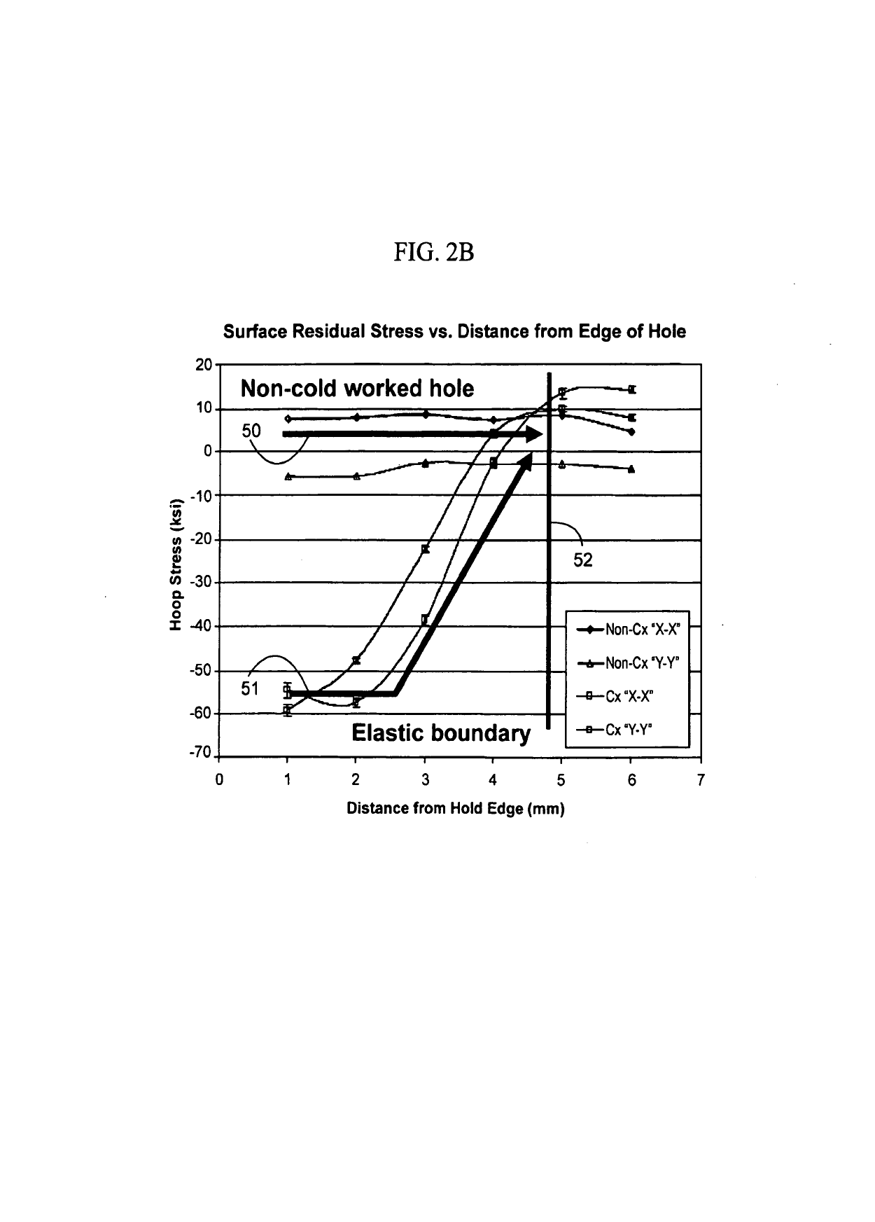

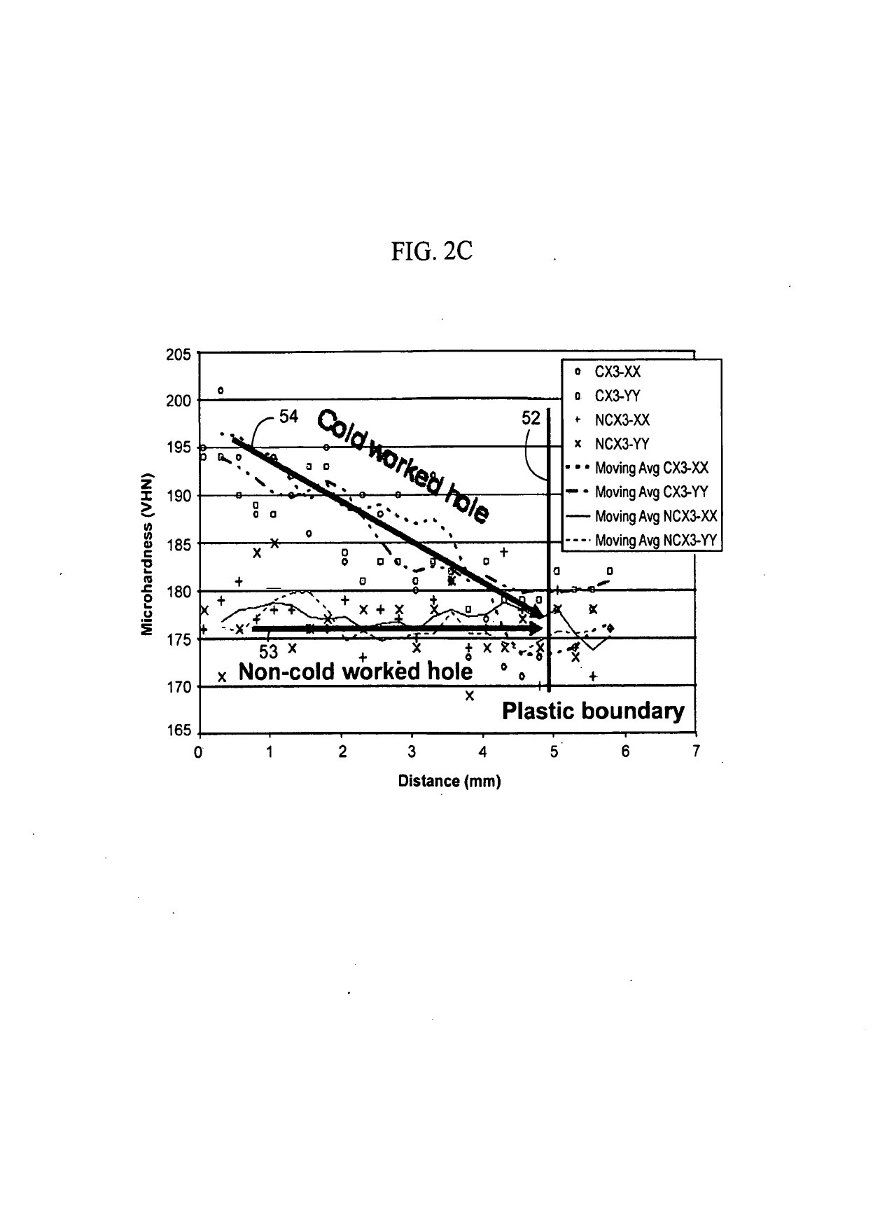

FIGS. 2A, 2B, and 2C depict the type and extent of material property zones around a cold worked hole. Test data presented in FIGS. 2B and 2C are for 7075-T6 aluminum. Referring to FIG. 2A, a reference specimen 5 with cold worked hole 65 is depicted. Cold worked zone 67 exists around the cold worked hole. Cold worked zone 67 has an inner cold worked boundary 6 and an outer cold worked boundary 7. Cold worked zone 67 exhibits both elastic stress and plastic strain components. Beyond outer cold worked boundary 7, there exists a zone with no cold work 8. FIG. 2B shows how the cold worked zone may be characterized for its stress component. FIG. 2C shows how the cold worked zone may be characterized for its strain component.

Referring now to FIG. 2B, a plot of hoop stress vs. the physical distance from the edge of the hole is shown. Numbers along the x-axis are units in millimeters (mm). Numbers along the y-axis are units of stress in kips per square inch (ksi). To generate the plot, stress measurements around a cold worked hole were taken along two axes in 1 mm increments. Beginning at the edge of the hole at the 3:00 o'clock position and moving horizontally to the right defines the X-X direction. Beginning at the edge of the hole at the 12:00 o'clock position and moving vertically defines the Y-Y direction. Stress measurements were taken using X-ray diffraction. X-ray diffraction is a commercial technique used to measure the distance between crystallographic planes, i.e. d-spacing, in crystallographic materials. The distance between planes is converted to stress using an effective elastic parameter. Standards exist that describe how to set up equipment, ASTM E 915-90, and determine elastic parameters, ASTM E 1426-91.

FIG. 2B shows that for cold worked hole stress measurements 51, a residual compressive stress between 50 ksi and 60 ksi (negative sign) exists out to around 2 mm from the hole edge. Then, stress gradually dissipates between around 2 mm and 4.5 mm away from the hole edge; thus, the outer stress boundary, or cold worked boundary 52 is around 4.5 mm from the hole edge. In contrast, non-cold worked hole stress measurements 50 remain relatively constant between 5 ksi compressive (negative) and 5 ksi (positive).

Referring now to FIG. 2C, a plot of microhardness vs. physical distance from the edge of the hole is shown, with microhardness being an indication of plastic strain. As described in for FIG. 2B, data were taken in the X-X direction and Y-Y direction. Vickers microhardness indentation was used to obtain hardness profiles of the cold worked area. Vickers hardness employs a pyramidal diamond indenter. Hardness is determined by applying a certain load to the material and measuring the average diagonal distances in the impression. The distance is correlated to the hardness of the material. Hardness can be defined as a resistance to plastic deformation. Metallurgy theory says that cold working increases dislocation density in a crystallographic material and higher dislocation content, due to plastic strain, increases the hardness of the material. The plot shows that for cold worked hole microhardness measurements 54, hardness near the edge of the hole is between 195 and 200 Vickers Pyramid Number (VHN). Then, hardness gradually dissipates to around 5 mm away from the hole edge; thus, the outer strain boundary, or cold worked boundary 52 is around 5 mm from the hole edge. In contrast, microhardness measurements on a non-cold worked hole 53 remain relatively constant around 175 VHN.

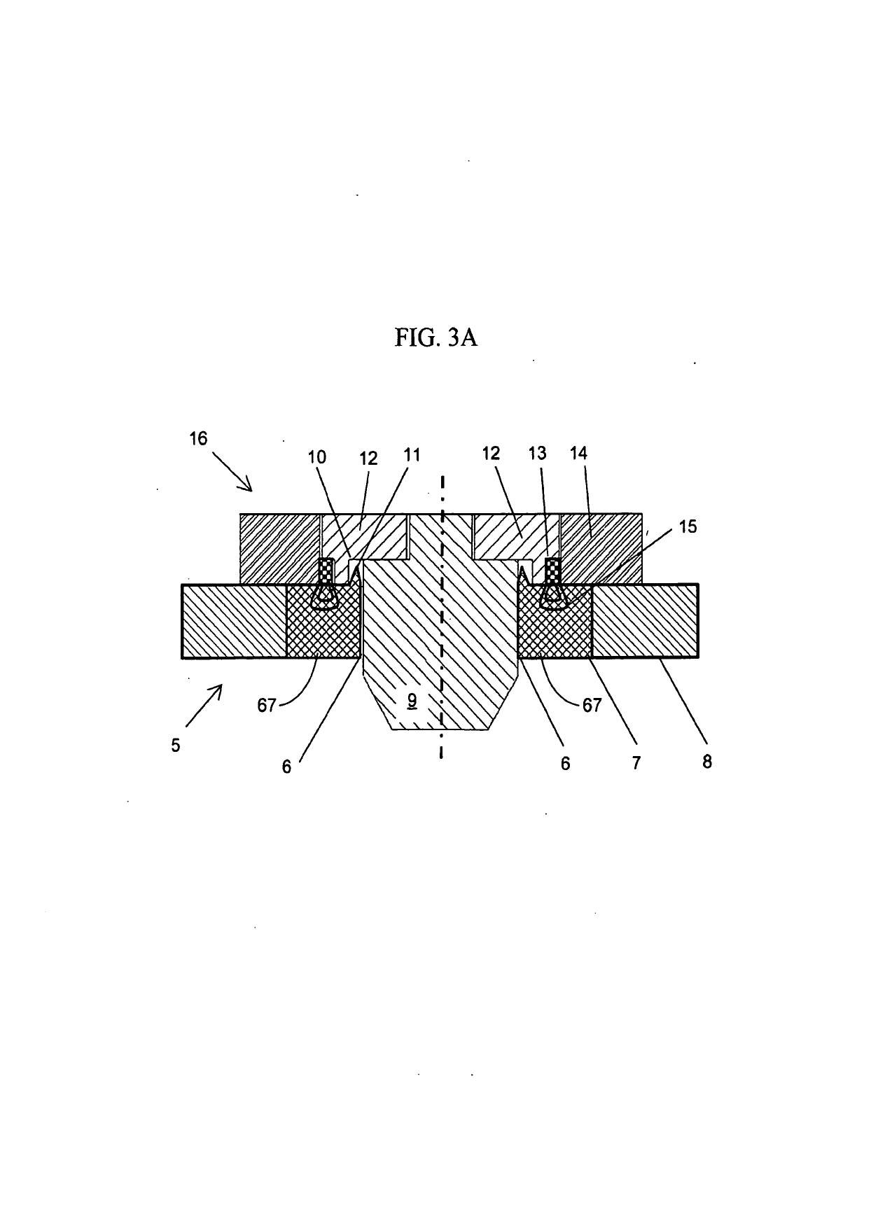

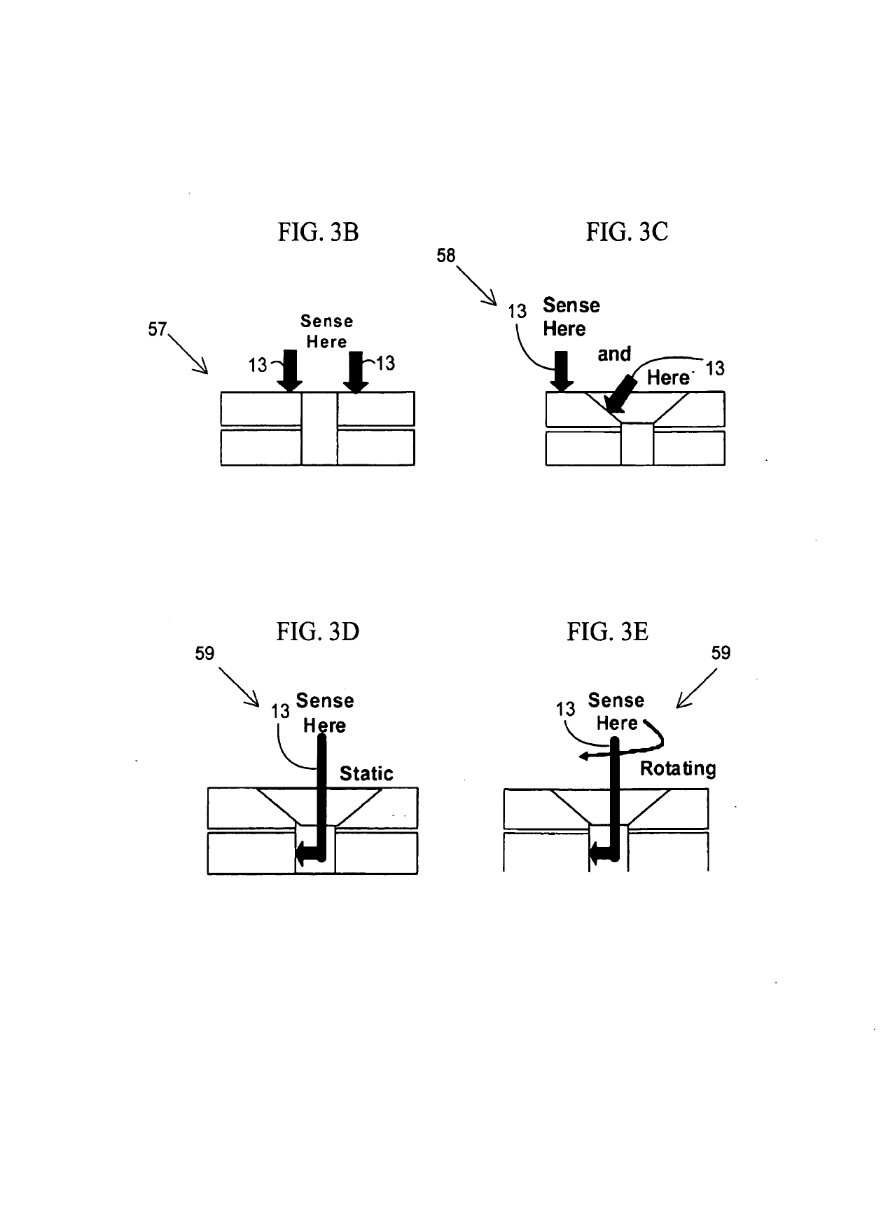

The two methods described above, X-ray diffraction and microhardness, were culled from a series of experiments that include other additional metallographic techniques such as optical microscopy and Orientation Image Microscopy, OIM, as the two best indicators for identifying and quantifying the cold worked boundary 52 around cold worked holes. Quantifying these boundaries makes it possible to specify a sensing footprint for a sensor that exclusively inspects cold worked material within the cold worked boundaries. FIGS. 3A through 3D depict sensor footprints for sensing cold worked material around straight and countersunk cold worked holes.

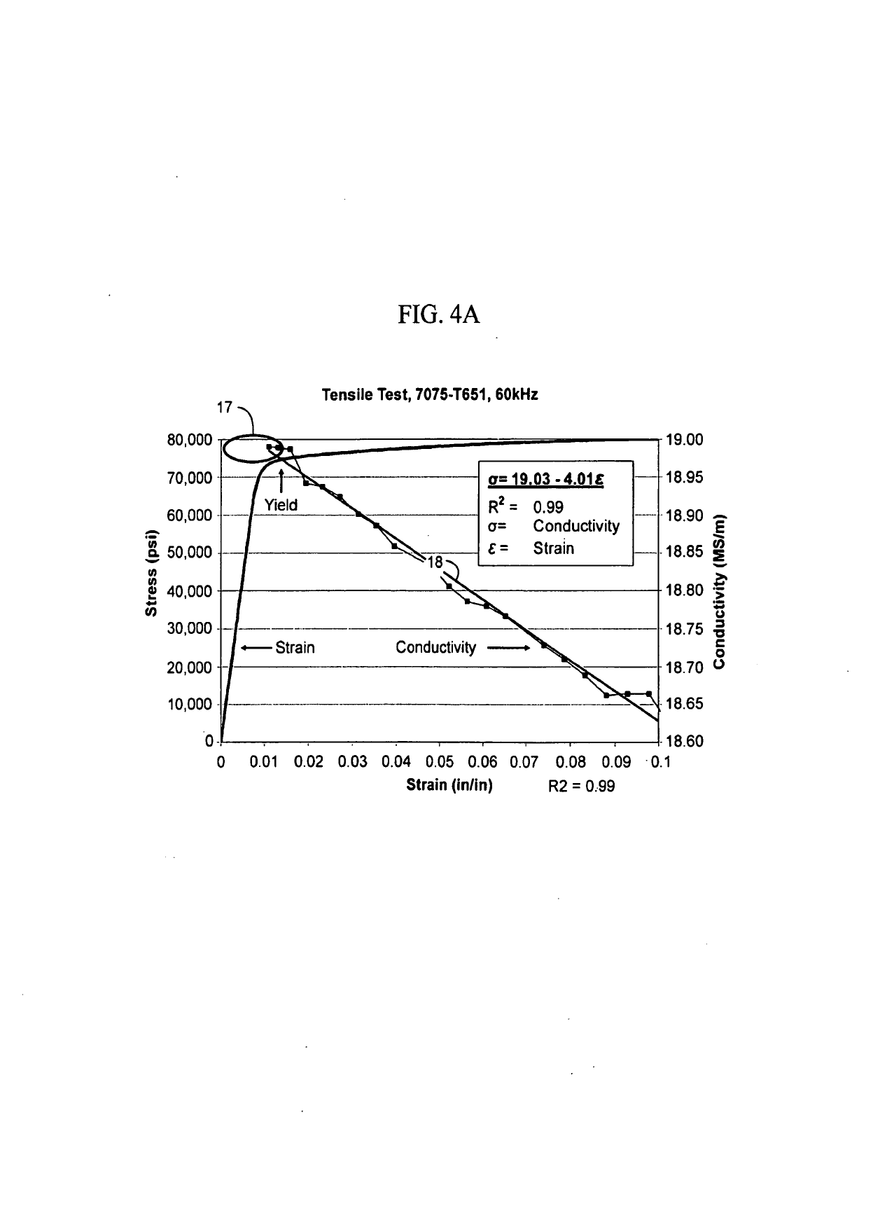

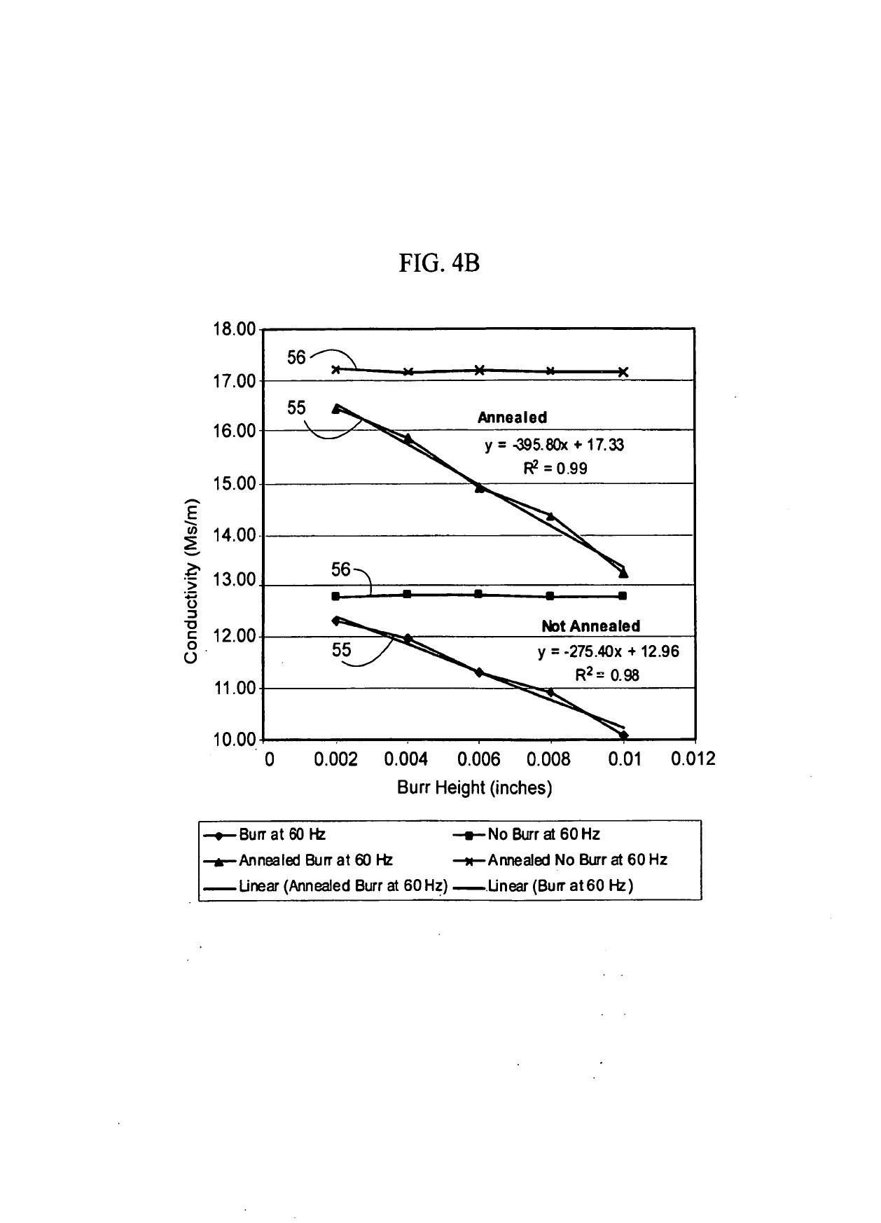

Referring now to FIG. 3A, a cross sectional diagram of a preferred embodiment of inductive eddy current sensor 16 is shown. In this embodiment, sensor 16 is shown resting on reference specimen 5 with cold worked hole 65. Sensor 16 comprises a centering pin or machine element 9 that serves to center sensor 16 on cold worked hole 65 at inner cold worked boundary 6. Sensor 16 further comprises inner magnetic shield 12 around the inside diameter of the sensor to prevent the sensor from detecting burrs and eddy current edge effects around hole 65. Burr 11 around the edge of a cold worked hole 65 results from a reaming process that is performed on cold worked holes. Burr 11, however, unduly affects the response of a typical eddy current probe as is discussed in reference to FIG. 4B so it is therefore required to prevent the probe from detecting burrs. A burr relief area 10 is provided in the design of sensor 16 so that the sensing element inductive coil 13 rests flat on a test specimen or reference specimen in spite of the presence of a burr. Outer magnetic shield 14 prevents the sensor from sensing material that has not been affected by cold working; termed not cold worked zone 8. The location of outer magnetic shield 14 is set to be slightly inside outer cold worked boundary 7 that was established in reference to FIG. 2C. These two shielding components 12, 14 around sensing element inductive coil 13, inner magnetic shield 12 and outer magnetic shield 14, constrain the magnetic flux of coil 13 to the region between shields 12, 14. Thus, the complex impedance of sensor coil 13 in the presence of cold worked material is not influenced by edge conditions around hole 65 and is not diluted by not cold worked material in not cold worked zone 8 beyond cold worked region 67 around cold worked hole 65. FIG. 3A illustrates this effect as alternating magnetic fields and eddy currents 15 are constrained to cold worked zone 67 which is outside burr 11 and inside not cold worked zone 8. The sensor coil's shielding and focusing of magnetic flux into a specific cold worked area was discovered by the applicants to be preferred in using eddy currents to inspect cold worked holes. Measurements taken by general purpose eddy current conductivity probes (1) are unduly influenced by edge conditions, discussed in reference to FIG. 4B, and (2) are diluted when areas outside the cold worked region are sensed along with cold worked material. The shielding and flux focus principle was demonstrated on a prototype of the embodiment disclosed herein to work on straight hole geometries that are provided to accept button head fasteners. In principle, the same shielding allows for the ability to inspect regions of countersunk hole geometries that accept flat head fasteners.

Referring now to FIGS. 3B, 3C, and 3D, a preferred location of sensing element inductive coil 13 residing within inductive eddy current sensor 16 is shown with dark arrows for different inspection situations. FIG. 3B discloses a preferred location for performing a straight hole surface inspection of straight hole surface inspection specimen 57 as described in reference to FIG. 3A. FIG. 3C discloses a preferred location for performing a countersunk hole surface inspection of countersunk hole surface inspection specimen 58. FIG. 3D discloses a preferred location for performing a countersunk or straight hole inspection at a layer inside the hole of countersunk or straight hole specimen 59. Sensor 16 may be stationary for a static inspection as illustrated in FIG. 3D or rotated for a rotating inspection as illustrated in FIG. 3E.

In an illustrative embodiment, inductive eddy current sensor 16, comprising shielded sensing element inductive coil 13, is positioned over cold worked material and detects electrical conductivity that has changed in response to cold working. FIGS. 2B and 2C depict how the cold worked zone exhibits both elastic stress and plastic strain. The applicants discovered that the electrical conductivity difference between cold worked material and material that has not been cold worked is largely caused by the presence of plastic strain and not residual stress as is commonly believed. This finding is surprising because conventional wisdom dictates that residual stress can be measured with eddy currents by correlating an eddy current electrical conductivity measurement to residual stress. However, the applicants found that elastic stress has little or no effect on conductivity measurements.

Referring now to FIG. 4A, a combined stress/strain diagram and plot of electrical conductivity as a function of strain for a 7075 series aluminum tensile test specimen is presented. To generate the data plot, a test specimen was pulled in an MTS Alliance RT/100 tensile test machine. A strain gage attached to the test specimen recorded total strain. A commercial eddy current conductivity probe, Sigmascope SMP 10, Helmut-Fischer Corporation, attached to the test specimen recorded electrical conductivity. A load cell within the tensile test machine recorded the load which was later converted to stress using Hook's law. The test specimen was pulled in a tensile direction and strain, electrical conductivity, and force were recorded. FIG. 4A shows a typical stress/strain curve and the electrical conductivity response. The conductivity response to stress 17 (i.e., during elastic strain) was essentially non-existent. However, once the test specimen began to yield (i.e. when permanent plastic deformation occurred), the electrical conductivity response to permanent deformation 18 (i.e., during plastic strain) decreased linearly as the specimen was pulled.

FIG. 4B illustrates the strong effect of burrs and edge effects around holes on electrical conductivity measurements using background art eddy current conductivity equipment. This correlation makes imperative the use a sensor embodiment presented herein and preferably the sensor embodiment described in the discussion of FIG. 3A. FIG. 4B is a plot of electrical conductivity as a function of burr height on machined aluminum test specimens taken using a commercial eddy current conductivity probe, Sigmascope SMP 10 model by Helmut-Fischer. Test specimens of 7075 alloy aluminum material with carefully machined burrs were used to generate the data plot. A standoff distance between the probe and specimen surface was set and held constant to control liftoff.

Referring again to FIG. 4B, the X-axis displays increasing burr heights in inches. The Y-axis displays electrical conductivity in megasiemens per meter (Ms/m). For the hole measurements, the conductivity response to no burrs 56 is flat at around 12.75 Ms/m and for the same set of test specimens but in an annealed condition is flat at around 17.25 Ms/m. In contrast, the conductivity response to burrs 55 began around 12.25 Ms/m for a burr height of 0.002 inches and decreased to around 10 Ms/m for a burr height of 0.010 mm. A similar correlation exists for the annealed specimens.

In addition to burr effects, edge effects also exist. Edge effects are known in the art as a leakage of eddy currents into free space when taking measurements near a cut edge of material. Hence, in addition to burr shielding, another need is to provide magnetic shields to mask out edge effects from holes as embodied in FIG. 3A. The published electrical conductivity for 7075-T6X material is around 18 Ms/m where as the measurement taken on a specimen with a hole using the commercial eddy current equipment described above was around 12.75 for the un-annealed material as presented in FIG. 3B. The disparity is attributed to the un-masked presence of the hole.

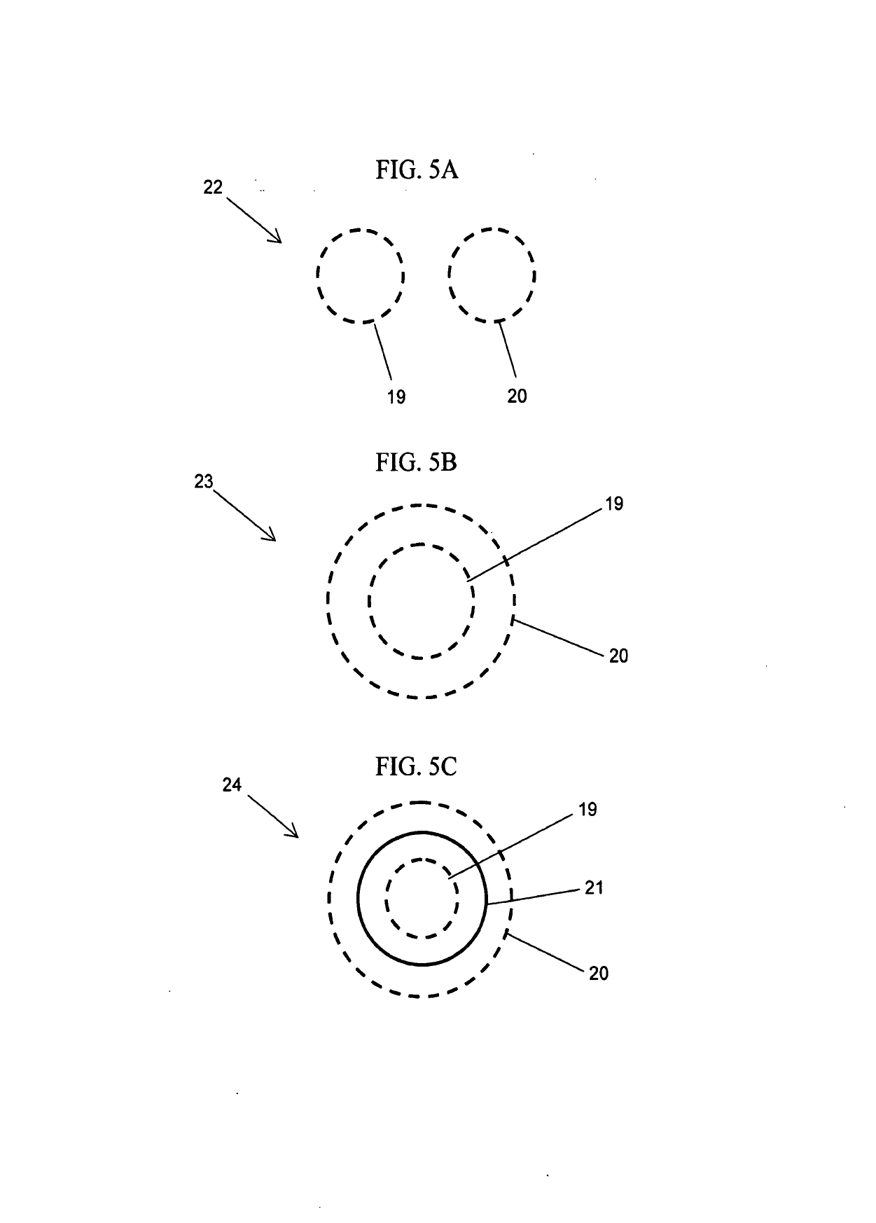

FIGS. 5A, 5B, and 5C are schematic line drawings of illustrative sensor arrangements in probe 3 wherein evaluation sensor 19 and reference sensor 20 are used to create a differential measurement. A differential measurement provides a relative measure of the effectiveness of cold working in the cold worked zone 67 around a hole compared to material in not cold worked zone 8. These embodiments are important because published conductivity values for one material of interest, 7075-T6 aluminum, range between 31.4 and 34.8 percent [International Annealed Copper Standard (IACS), NDT Education Resource Center, Brian Larson, Editor, 2001-2011, The Collaboration for NDT Education, Iowa State University, at WWW domain: ndt-ed.org/GeneralResources/MaterialProperties/ET/Conductivity_Al.pdf], with a mean of 33.1 percent. This range equates to a 10.2 percent variation relative to the mean for published electrical conductivity tolerances on this material. Physical strain applied to cold worked holes is around 4 percent nominal with 6 percent being an over strained condition. Measured electrical conductivity variation over a physical strain range between zero percent and strain at 6 percent is around 1.2 percent electrical variation relative to no strain conductivity. Although a 1.2 percent variation in electrical conductivity is readily quantifiable, an absolute measurement by itself is not meaningful considering the variation in electrical conductivity for commercial material 10.2 percent. Therefore, illustrative embodiments disclosed herein for measuring cold worked holes includes both a measurement in cold worked zone 67 around the hole and a measurement in not cold worked zone 8.

Referring now to FIG. 5A, evaluation sensor 19 is depicted in a side by side sensor arrangement 22 with reference sensor 20. FIG. 5B shows an arrangement wherein reference sensor 20 (which may comprise a first plurality of sensor coils 13) is outside and concentric to evaluation sensor 19 (which may comprise a second plurality of sensor coils 13) thereby comprising concentric sensor arrangement 23. In both cases, evaluation sensor 19 is positioned over cold worked zone 67 and reference sensor 20 is positioned over not cold worked zone 8 to produce a difference in measurements or a differential measurement. That is each sensor 19, 20 may take an individual measurement consecutively or simultaneously or the sensors 19, 20 may be placed in a differential bridge circuit as described in the discussion of FIGS. 6 and 7. FIG. 5C depicts concentric exciting-excited arrangement 24 wherein exciting sensor 21 supplies a single primary magnetic excitation field and evaluation sensor 19 and reference sensor 20 detect secondary magnetic fields from excited eddy currents, induced by exciting sensor 21 in the reference and test specimens.

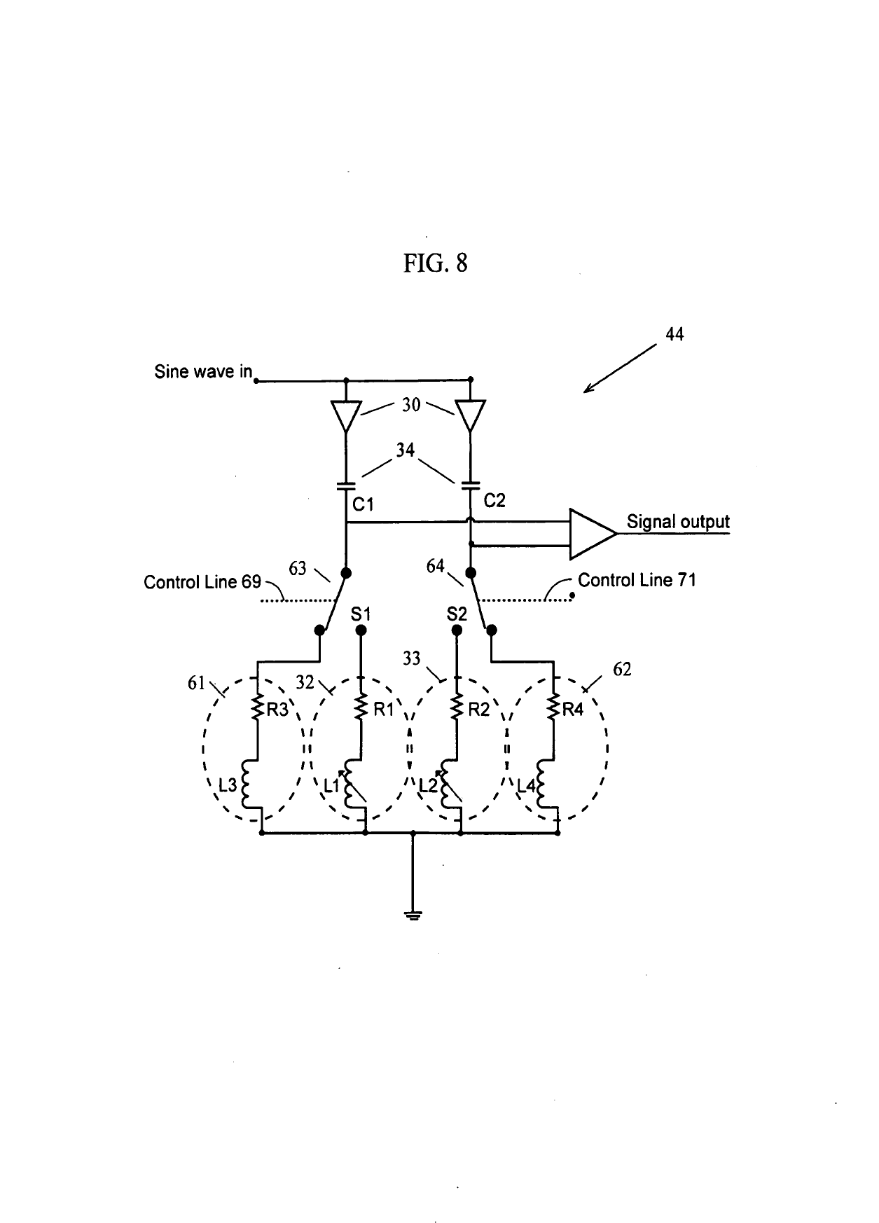

FIG. 6 is a cross sectional view of a preferred embodiment of probe 3 that comprises two sensor 19, 20, a resonant bridge circuit 26, and housing 25. In this embodiment, evaluation sensor 19 is shown in a side by side sensor arrangement 22 with reference sensor 20. Both sensors 19, 20 are contained within a housing 25. The sensors 19, 20 may be guided and spring loaded in order to consistently position them against a test specimen and physically control liftoff. Housing 25 also serves as a hand held package for the sensor arrangement. Signal conditioning circuit board 26 is shown to be preferably disposed within housing 25 in order to be in close proximity to sensors 19, 20. Circuitry preferably located on signal conditioning circuit board 26 reduces signal loss, environmental noise, and parasitic inductance that can occur in interconnect cable 4 joining probe 3 to detector circuit 35 (FIG. 8) that is preferably located in detector 2.

FIG. 7 presents a circuit diagram for an illustrative embodiment of signal conditioning circuit board 26. In this embodiment, the circuit 26 comprises resonant filter bridge 27 and instrumentation amplifier 31. Bridge circuits are commonly used for precise differential measurements and many versions exist. However, all these bridge circuits are of a general structure that comprise two legs or four branches that contain passive impedance elements. The impedance elements may be resistors, inductors, capacitors, or a combination of parallel or series impedance elements. Resonant filter bridge 27 disclosed here in differs in that the bridge legs are designed with passive reactive elements that behave as a resonant filter. The legs also preferably include buffer amplifiers 30.

In this embodiment, resonant filter bridge 27 is a full bridge arrangement comprising “sensing” sensor (e.g., evaluation sensor coil elements 32) in one leg of the bridge and a “reference” sensor (e.g., reference sensor coil elements 33) in another leg of the bridge. The sinusoidal output from each leg of the bridge, left leg 28 and right leg 29, are fed to instrumentation amplifier 31. Instrumentation amplifier 31 subtracts one leg signal from the other leg signal and yields a differential output signal to which gain may be applied to amplify the product differential signal. The passive reactive elements located in each leg of the resonant filter bridge 27 are capacitors 34 whose capacitance values are chosen to work in combination with reactive sensor coils elements 32, 33. Reactive sensor coil elements, 32, 33 are shown in the figure as their equivalent circuit, i.e., a series resistor and inductor. The combination of passive reactive elements is preferably tuned to operate at or near a resonant frequency that coincides with a selected eddy current inspection signal frequency, e.g., 50 kHz. The advantage of operating the bridge circuit, comprising legs of reactive components and eddy current sensors, near resonance is that small impedance change on a sensor in contact with cold worked material produces large phase and amplitude shifts in output signal frequency which can be easily measured using known circuit techniques. An additional advantage of this bridge circuit arrangement is that the capacitor values may be selected so that the sensor becomes more sensitive to electrical conductivity variation and less sensitive to liftoff.

Liftoff is an incomplete coupling between an eddy current sensor and a test part. Liftoff is caused by the presence of a coating such as paint, probe wobble, or out of plane distortions in the material surrounding a cold worked hole. A low inspection signal frequency, e.g. about 50 kHz, helps mitigate some of the liftoff effect, but the remainder must be compensated for mechanically, electrically, algorithmically, or a combination thereof which is preferred.

Buffer amplifiers 30 located in each leg of resonant filter bridge 27 provide four beneficial attributes. The first is to obtain electrical isolation between sensing legs 28, 29. The second is to amplify current to excite the sensors 32, 33. The third is to provide low output impedance to the resonant filter of each leg. Low output impedance increases the quality factor, Q, of each leg. A high Q circuit displays a peaked frequency response and in this application, a stronger resonant response. The forth is to serve as a buffer amplifier that provides high input impedance to the frequency signal generator that is part of apparatus 1.

FIG. 8 illustrates a modified circuit diagram with the addition of a coil switching capability. Two analog switches S1 (first analog switch 63) and S2 (second analog switch 64) are controlled by first digital control line 69 and second control line 711 allow the switching of evaluation coil 32 to first dummy coil 61 and the switching of reference coil 33 to second dummy coil 62. Each of the dummy coils comprises a temperature stable or low drift resistor and inductor pair. This alternative circuit configuration is herein defined as switch-mode conditioning circuit board 44. Four different coil configuration modes are allowed by switch-mode circuit 44. The four different coil configuration modes are as follows: evaluation-to-reference mode, evaluation-to-dummy mode, dummy-to-reference mode, and dummy-to-dummy mode. The additional switching capability introduced to switch-mode circuit 44 allows self-calibration of switch-mode circuit 44 to mitigate the gain and offset drifting of system 36 due to heating or warming up of circuit components. It is well-known in the art that components such as instrumentation amplifier 31 is tend to have its gain and offset values vary with the component's temperature changes as the result of components warming up. Switching both evaluation coil 32 and reference coil 33 to temperature stable dummy coils 61, 62 (dummy-to-dummy mode) permits measurement of drifting effect of sensor detector system 36. Normalizing the output measurement of the evaluation-to-reference mode to the output measurement of the dummy-to-dummy mode mitigates the drifting effect of sensor detector system 36.

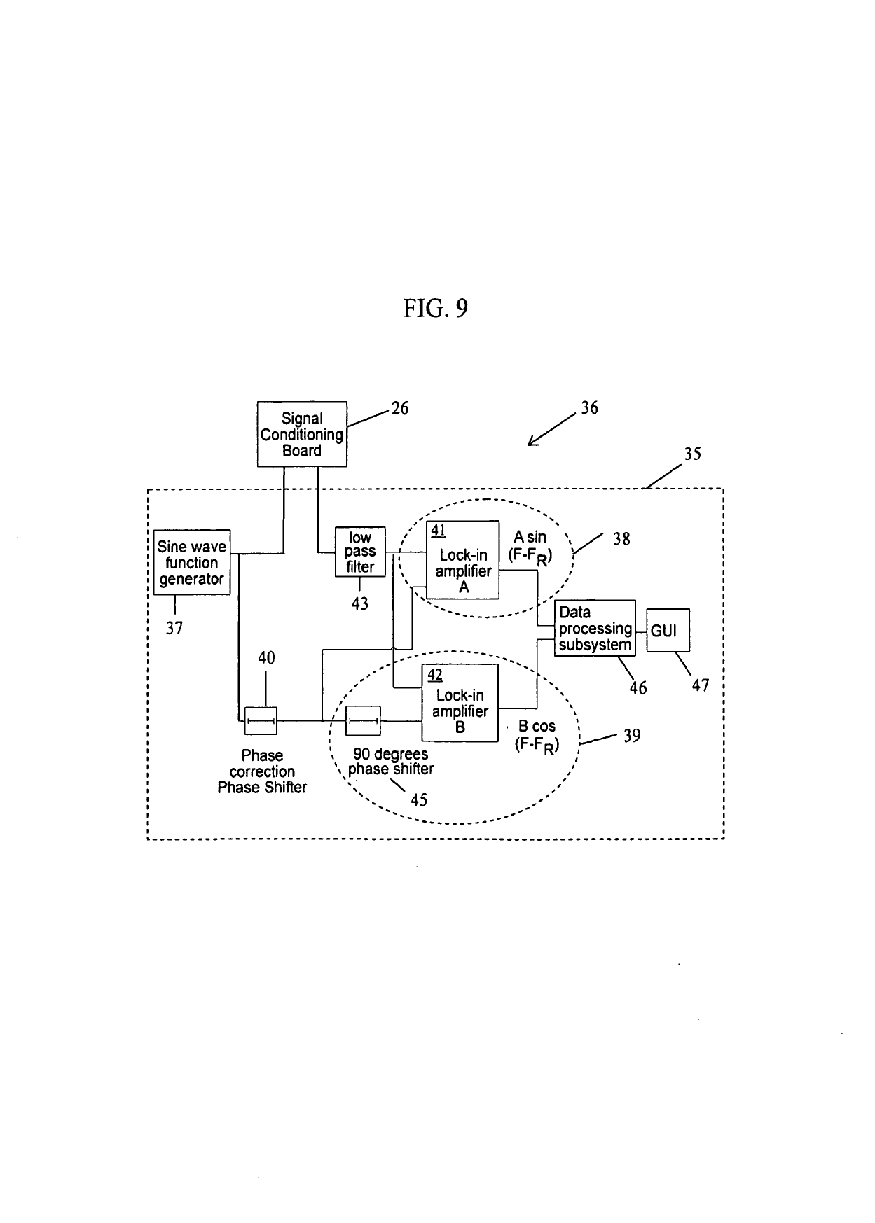

FIG. 9 presents a diagram of an illustrative embodiment of sensor detector system 36. In this embodiment, system 36 comprises signal conditioning board 26 and main detector circuit board 35. Main detector circuit board 35 is preferably physically located in detector 2. Signal conditioning board 26 is preferably physically located in probe 3. They are connected to each other though interconnect cable 4.

In this embodiment, main detector circuit board 35 comprises sine wave function generator 37, phase correction phase shifter 40, primary lock-in amplifier circuit 38, secondary lock-in amplifier circuit 39, data processing subsystem 46 that correlates the measurement data into cold-work data to be displayed, and graphic user interface 47 that display the cold-work data. Sine wave function generator 37 generates the signal source for (1) signal conditioning board 26 to excite sensors 32, 33 connected to the board and (2) reference to lock-in amplifier circuits 38, 39. The reference signal is preferably phase adjusted using phase shifter 40 for tuning purposes. Primary lock-in amplifier circuit 38 preferably comprises analog lock-in amplifier chipset 41. Lock-in amplifier chipset 41 may alternatively be implemented as algorithms on a microprocessor. Low pass filter 43 is preferably included to reduce noise on the input. The secondary lock-in amplifier circuit 39 shown is a duplicate of primary lock-in amplifier circuit 38 but includes 90-degree phase shifter 45 that is connected to the reference signal line. Secondary lock-in amplifier circuit 39 is not an essential circuit element to the detection method described but is included on the detector circuit board to illustrate how the detector circuit may be include additional functionality. The signal output of secondary lock-in amplifier circuit 39 is inversely proportional to the signal of primary lock-in amplifier circuit 38 but not linearly proportional. Characterizing the relationship between the two as sensor coil impedance varies in response to measuring cold working provides another means of correlating a sensor response to a reference value.

In an illustrative embodiment, probe 3 comprises one or more sensor coil assemblies 16 that are spring loaded or actuated in such a way that a tight mechanical interface is made between the sensor coils 13 in the assembly and the material under evaluation. In another embodiment, an electronic signal conditioning circuit 26 is located in close proximity to the sensors in order to (1) mitigate electronic noise susceptibility between the sensor coils 13 and signal conditioning circuit 26 and (2) minimize wire inductance in the interconnect cable 4 between sensor coils 13 and amplification circuitry located on signal conditioning circuit 26 because an inductance change on sensor coils 13 is a desired measurement and parasitic inductance in interconnect cable 4 is detrimental to the sensor measurement. In another embodiment, probe 3 comprises an enclosure that houses sensor coil assemblies 16 and other electrical circuitry, and provides a connector that accommodates interconnect cable 4 that is used for communicating to and from detector 2.

Operation of an illustrative embodiment of the invention involves a power-on step in which detector 2 is powered on and allowed to temperature stabilize, preferably for a few minutes. Then, in a not cold work calibration step, probe 3 is placed in contact with (zero liftoff) (or in a known close proximity to) a portion of a first reference specimen 5 having a not cold worked hole and a first reference measurement is taken. In a cold work calibration step, probe 3 is placed in contact with (on in the same known close proximity to) a part of a second reference specimen 5 having a cold worked hole and a second reference measurement is taken. The calibration step entails taking the measurement for no cold work and producing a first calibration reading, for example 0 percent, and taking the measurement for maximum anticipated cold work and producing a second calibration reading, for example 6 percent. This establishes (1) a measurement range between lower and upper extents of cold working effectiveness and (2) baseline measurements for correlating electrical values to cold work values. Calibration is performed at the start of an inspection procedure for each material alloy that is to be inspected, for example, 6061-T6 aluminum or 2024-T3 aluminum. With the lower and upper boundaries of cold working effectiveness quantified and stored, preferably in the memory or data storage component of data processing subsystem 46, the range may then be divided into intermediate values that analyzer 1 uses to (1) correlate measurements to useful numbers representing levels of cold work or (2) determine whether a measurement is above or below a predetermined threshold level.

Next, in an inspection initiation step, probe 3 is placed in contact with (or in the same known close proximity to) a portion of a test specimen having a cold worked hole that is to be inspected and qualified. In a testing step, a button is pushed which prompts detector 2 to acquire a measurement. The measurement is taken and stored, preferably in the memory or data storage component of data processing subsystem 46. Then, in a data processing step, the stored measurement is transformed by algorithms resident in a processor component of data processing subsystem 46 into a useful number that represents cold work effectiveness. That number is then shown to the user on a display that is a component of graphic user interface 47 and saved for record keeping purposes in the memory or data storage component of data processing subsystem 46.

In this embodiment, the algorithms operate on test measurements as follows. A test measurement comprises a phase change and an amplitude change between a reference signal that is not affected by the eddy currents induced in a test specimen and a test signal that is influenced by those eddy currents. In the art, the term for this phase and amplitude change is polar. The phase and amplitude data may also be displayed on graphic user interface 47 in rectangular form comprising two components, real and imaginary. In the art, the term for this is a data point location in the complex impedance plane.

Eddy current literature describes how electrical conductivity and liftoff affect sensor response in the complex impedance plane. In an illustrative embodiment, the algorithms correlate an electrical conductivity response in the complex impedance plane to cold work effectiveness by (1) quantifying the response to 0 percent cold work, (2) quantifying the response to a higher value of cold work, for example 6 percent, and (3) determining where in the range an unknown test measurement falls.

### WORKING EXAMPLE

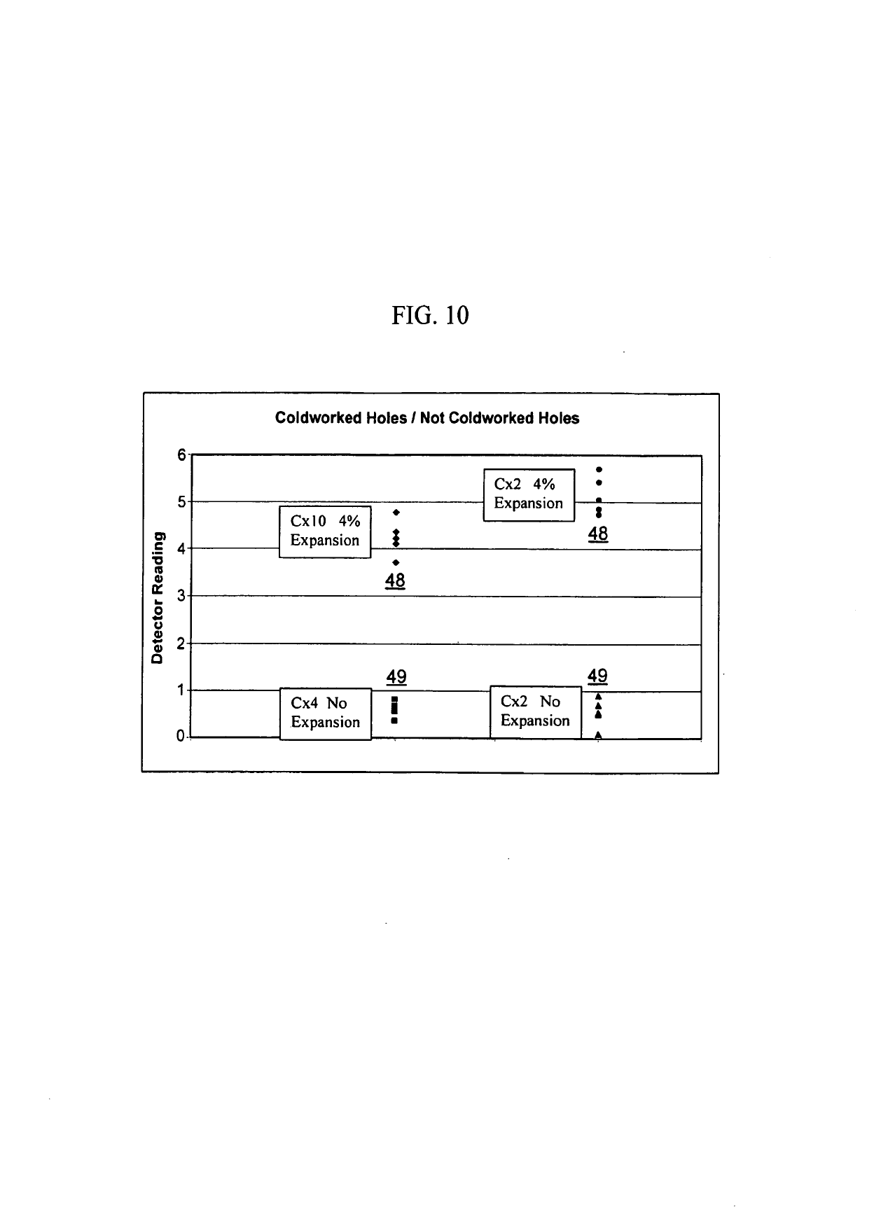

FIG. 10 presents data taken with a disclosed embodiment of analyzer 1 on cold worked holes and not cold worked holes. Each specimen was measured randomly five times. For the cold worked holes, the average detector reading 48 was around 4 for one specimen and around 5 for the other specimen. For the not cold worked holes, the average detector reading was around 0.50 for both specimens.

In summary, illustrative embodiments of the invention may be used to detect electrical conductivity changes in material adjacent to (around) cold worked holes and correlate the conductivity changes to a degree of cold work effectiveness. Other illustrative embodiments may be used to detect electrical conductivity changes in shot-peened material and correlate the conductivity changes to the degree or depth of shot-peening. Other illustrative embodiments may be used to detect electrical conductivity changes in a material wherein the surface of the material has been cold worked via any manufacturing process, typically for the purpose of inducing a residual compressive stress in the material. Other illustrative embodiments may be used to detect electrical conductivity changes in any material that has been cold worked, tempered, hardened, or altered in a manufacturing process that changes material's electrical conductivity and then correlate the conductivity changes to the process for the purpose of qualifying the manufacturing process. Other embodiments may be used to detect electrical conductivity changes in cold worked material wherein the material has not been intentionally cold worked but rather unintentionally deformed or flexed beyond its elastic limit. Other embodiments may be used to detect impedance changes on an electrically reactive sensor and correlate the impedance change back to the source wherein the impedance change is caused by: (1) sensor proximity to a nonferrous electrically conductive material, (2) sensor proximity to a ferrous electrically conductive material, (3) sensor proximity to ferro or ferri magnetic materials, or (4) sensor response to contact with any electrically conductive or ferri or ferro magnetic material.

Many variations of the invention will occur to those skilled in the art. Some variations include a coil switching capability. Other variations do not. All such variations are intended to be within the scope and spirit of the invention. Although some embodiments are shown to include certain features or steps, the applicant(s) specifically contemplate that any feature or step disclosed herein may be used together or in combination with any other feature or step on any embodiment of the invention. It is also contemplated that any feature or step may be specifically excluded from any embodiment of the invention.

What is claimed is:

1. A nondestructive evaluation method for determining cold working effectiveness of a test specimen, said nondestructive evaluation method comprising:
imposing a changing primary magnetic field on a cold worked portion of a first reference specimen having a first cold worked value that is known, substantially shielding the remaining portion of said first reference specimen from said changing primary magnetic field, and electromagnetically inducing a first eddy current in said cold worked portion with a coil to cause said reference specimen to produce a first secondary magnetic field;
measuring a first response in said coil to said first secondary magnetic field to produce a first reference signal having a first reference value;
imposing said changing primary magnetic field on a not cold worked portion of said first reference specimen or a second reference specimen having a second cold worked value that is known, substantially shielding the remaining part of said first reference specimen or a second reference specimen from said changing primary magnetic field, and electromagnetically inducing a second eddy current in said not cold worked portion with said coil to cause said first reference specimen or said second reference specimen to produce a second secondary magnetic field;
measuring a second response in said coil to said second secondary magnetic field to produce a second reference signal having a second reference value;
using said first reference values and said second reference value to establish a measurement range of cold working effectiveness and to correlate each of said reference values with a cold work effectiveness value, and placing said measurement range and said correlation in a memory;
imposing said changing primary magnetic field on a test portion of the test specimen having an unknown cold worked value, substantially shielding the remainder of said test specimen from said changing primary magnetic field, and electromagnetically inducing a test eddy current in said test portion with said coil to cause the test specimen to produce a test secondary magnetic field;
measuring a test response in said coil to said test secondary magnetic field to produce a test signal having a test value;
using said measurement range and said correlation in processing said test value to determine a cold work effectiveness value for said test portion of the test specimen.

2. A nondestructive evaluation method for determining cold working effectiveness of a cold worked portion of a test specimen, said nondestructive evaluation method comprising:
generating an eddy current in the cold worked portion with changing magnetic field produced by an alternating current in a coil to produce a secondary magnetic field, while shielding the remainder of the test specimen from said changing magnetic field;
measuring test changes in the resistance and the inductive reactance of said coil caused by said secondary magnet field; and
comparing said test changes to reference changes measured on a reference specimen and determining the cold working effectiveness of the cold worked portion of the test specimen.

3. A nondestructive evaluation method for determining cold working effectiveness of a test specimen, said nondestructive evaluation method comprising:
a step for imposing a changing primary magnetic field on a cold worked portion of a first reference specimen having a first cold worked value that is known, substantially shielding the remaining portion of said first reference specimen from said changing primary magnetic field, and electromagnetically inducing a first eddy current in said cold worked portion with a coil to cause said reference specimen to produce a first secondary magnetic field;
a step for measuring a first response in said coil to said first secondary magnetic field to produce a first reference signal having a first reference value;
a step for imposing said changing primary magnetic field on a not cold worked portion of said first reference specimen or a second reference specimen having a second cold worked value that is known, substantially shielding the remaining part of said first reference specimen or a second reference specimen from said changing primary magnetic field, and electromagnetically inducing a second eddy current in said not cold worked portion with said coil to cause said first reference specimen or said second reference specimen to produce a second secondary magnetic field;
a step for measuring a second response in said coil to said second secondary magnetic field to produce a second reference signal having a second reference value;
a step for using said first reference values and said second reference value to establish a measurement range of cold working effectiveness and to correlate each of said reference values with a cold work effectiveness value, and placing said measurement range and said correlation in a memory;
a step for imposing said changing primary magnetic field on a test portion of the test specimen having an unknown cold worked value, substantially shielding the remainder of said test specimen from said changing primary magnetic field, and electromagnetically inducing a test eddy current in said test portion with said coil to cause the test specimen to produce a test secondary magnetic field;
a step for measuring a test response in said coil to said test secondary magnetic field to produce a test signal having a test value;
a step for using said measurement range and said correlation in processing said test value to determine a cold work effectiveness value for said test portion of the test specimen.

4. A nondestructive evaluation method for determining cold working effectiveness of a cold worked portion of a test specimen, said nondestructive evaluation method comprising:
a step for generating an eddy current in said cold worked portion with changing magnetic field produced by an alternating current in a coil to produce a secondary magnetic field, while shielding the remainder of the test specimen from said changing magnetic field;
a step for measuring test changes in the resistance and the inductive reactance of said coil caused by said secondary magnet field; and
a step for comparing said test changes to reference changes measured on a reference specimen and determining the cold working effectiveness of the cold worked portion of the test specimen.

5. A nondestructive evaluation apparatus for determining cold working effectiveness of a test specimen, said nondestructive evaluation apparatus comprising:
means for imposing a changing primary magnetic field on a cold worked portion of a first reference specimen having a first cold worked value that is known, substantially shielding the remaining portion of said first reference specimen from said changing primary magnetic field, and electromagnetically inducing a first eddy current in said cold worked portion with a coil to cause said reference specimen to produce a first secondary magnetic field;
means for measuring a first response in said coil to said first secondary magnetic field to produce a first reference signal having a first reference value;
means for imposing said changing primary magnetic field on a not cold worked portion of said first reference specimen or a second reference specimen having a second cold worked value that is known, substantially shielding the remaining part of said first reference specimen or a second reference specimen from said changing primary magnetic field, and electromagnetically inducing a second eddy current in said not cold worked portion with said coil to cause said first reference specimen or said second reference specimen to produce a second secondary magnetic field;
means for measuring a second response in said coil to said second secondary magnetic field to produce a second reference signal having a second reference value;
means for using said first reference values and said second reference value to establish a measurement range of cold working effectiveness and to correlate each of said reference values with a cold work effectiveness value, and placing said measurement range and said correlation in a memory;
means for imposing said changing primary magnetic field on a test portion of the test specimen having an unknown cold worked value, substantially shielding the remainder of said test specimen from said changing primary magnetic field, and electromagnetically inducing a test eddy current in said test portion with said coil to cause the test specimen to produce a test secondary magnetic field;
means for measuring a test response in said coil to said test secondary magnetic field to produce a test signal having a test value;
means for using said measurement range and said correlation in processing said test value to determine a cold work effectiveness value for said test portion of the test specimen.

6. A nondestructive evaluation apparatus for determining cold working effectiveness of a cold worked portion of a test specimen, said nondestructive evaluation apparatus comprising:
means for generating an eddy current in said cold worked portion with a changing magnetic field produced by an alternating current in a coil to produce a secondary magnetic field, while shielding the remainder of the test specimen from said changing magnetic field;
means for measuring test changes in the resistance and the inductive reactance of said coil caused by said secondary magnet field; and
means for comparing said test changes to reference changes measured on a reference specimen and determining the cold working effectiveness of the cold worked portion of the test specimen.

7. An analyzer for a workpiece comprising a portion situated around a cold worked hole and a remaining portion, said analyzer comprising:
a probe comprising a first sensing element inductive coil for producing a first changing magnetic field that induces a first eddy current in the portion situated around the cold worked hole and for producing a first output signal, a centering pin or machine element for centering said first sensing element over the portion situated around the cold worked hole, a first inner magnetic shield that is disposed adjacent to said centering pin or machine element and between said centering pin or machine element and said sensing element inductive coil that effectively shields the edge of the hole from said changing magnetic field, and a first outer magnetic shield that is disposed adjacent to said first sensing element inductive coil and said first inner magnetic shield that effectively shields the remaining portion of the workpiece from said first changing magnetic field, a second sensing element inductive coil for producing a second changing magnetic field that induces a second eddy current in the remaining portion and for producing a second output signal, a second inner magnetic shield that is disposed adjacent to said second sensing element inductive coil, a second outer magnetic shield that is disposed adjacent to said second sensing element inductive coil and said second inner magnetic shield that effectively shields a portion of the workpiece away the cold worked hole from said second changing magnetic field, and a signal conditioning circuit board that is operative to send input signals to said sensing element inductive coils and to receive said output signals from said sensing element inductive coils, a signal conditioning circuit board that is operative to send an input signal to said sensing element inductive coil and to receive said output signal from said sensing element inductive coil;
a detector comprising a main detector circuit board that comprises a sine wave generator, a phase correction phase shifter, a ninety degrees phase shifter, a first lock-in amplifier, a data processing subsystem, a graphic user interface, a second lock-in amplifier and a low pass filter; and
an interconnect cable that connects said probe to said detector and supports two-way communication between said detector and said probe;
wherein said sine wave generator is operative to input a sine wave signal to said signal conditioning circuit board and to said phase correction phase shifter;
wherein said phase correction phase shifter is operative to input a phase corrected signal to said ninety degrees phase shifter and to said second lock-in amplifier;
wherein said ninety degrees phase shifter is operative to input a phase shifted signal to said first lock-in amplifier;
wherein said first lock-in amplifier is operative to input a first amplified signal to said data processing subsystem, to said second lock-in amplifier, and to said low pass filter;
wherein said low pass filter is operative to receive an output signal from said signal conditioning circuit board;
wherein said second lock-in amplifier is operative to input a second amplified signal to said data processing subsystem; and
said data processing subsystem is operative to process said amplified signals and to send and receive interface signals from said graphic user interface.

8. A nondestructive evaluation kit for determining whether a cold worked hole in an electrically conductive specimen is cold worked to an acceptable level, said nondestructive evaluation kit comprising:
an enclosed sensor probe that is operative to generate an eddy current in a portion of the electrically conductive specimen around the cold worked hole and not in the remainder of the electrically conductive specimen, to evaluate said portion for cold work effectiveness, and to produce an output signal;
an enclosed detector that is operative to send an input signal to said enclosed sensor probe, to process the output signal from said sensor probe, to produce a result, and to communicate said result with a user;
an interconnect cable that is operative to transfer two way communications between said enclosed sensor probe and said enclosed detector; and
a reference specimen having a known cold work effectiveness that is operative to cause said enclosed sensor probe to produce a reference output signal when said reference specimen is evaluated by said enclosed sensor probe.

9. The nondestructive evaluation kit of claim 8 wherein the electrically conductive specimen is comprised of aluminum, mild steel, steel, titanium, or one of their alloys, or a nickel based alloy.

10. The nondestructive evaluation kit of claim 8 wherein said reference specimen has a hole that has been drilled, reamed, cold expanded, and post reamed, and said reference specimen comprises:
an annular cold worked zone around said hole that contains plastic strain identified using metallographic microhardness and elastic strain identified using X-ray diffraction, said annular cold worked zone having an inner boundary and an outer boundary; and
a zone outside of said annular cold worked zone that does not have cold work properties.

11. The nondestructive evaluation kit of claim 8 wherein said portion is an annular zone and said enclosed sensor probe comprises:
a sensing element in the form of an inductive coil that is operative to generate primary alternating magnetic fields in said annular zone around a cold worked hole wherein said alternating magnetic fields induce alternating eddy currents in the electrically conductive substrate, wherein said alternating eddy currents in the electrically conductive substrate are operative to create secondary alternating magnetic fields which oppose the alternating magnetic fields being generated by said sensing element, wherein interaction among the primary and secondary alternating magnetic fields is operative to affect a complex impedance of said sensing element in a way that indicates the cold work effectiveness in said annular zone;
a centering pin or machine element that is operative to locate said sensing element concentric to the cold worked hole;
a burr relief area around said centering pin or machine element that is operative to allow said enclosed sensor probe to rest flat on a surface of said electrically conductive specimen around the cold worked hole;
an inner magnetic shield that is disposed around said centering pin or machine element that is operative to prevent said complex impedance response of the eddy current sensor from being influenced by the presence of a burr, the size of the burr, or an edge effect around the cold worked hole; and
an outer magnetic shield that is disposed around said sensing element that is operative to prevent said complex impedance response of the eddy current sensor from, being influenced by an eddy current in material outside the cold worked area, or an adjacent edge effect from an adjacent hole that is disposed adjacent the cold worked hole.

12. The nondestructive evaluation kit of claim 11 wherein said magnetic shields comprise a material of construction having a magnetic permeability property which is operative to provide a low magnetic reluctance path for shaping said primary alternating magnetic fields.

13. The nondestructive evaluation kit of claim 11 wherein said magnetic shields comprise a magnetic material that is formable or machinable.

14. The nondestructive evaluation kit of claim 13 wherein said magnetic shields comprise a mu-metal alloy or a ferrous material.

15. The nondestructive evaluation kit of claim 11 wherein said magnetic shields comprise a magnetic material that is castable into an annular shape.

16. The nondestructive evaluation kit of claim 11 wherein said magnetic shields comprise a ferrite material.

17. The nondestructive evaluation kit of claim 11 wherein said enclosed sensor probe is configured so as to be capable of evaluating cold worked hole diameters ranging from ⅛ inch to 1 inch.

18. The nondestructive evaluation kit of claim 11 wherein said enclosed sensor probe is configured so as to be capable of evaluating a straight hole used with a button head fastener.

19. The nondestructive evaluation kit of claim 11 wherein said enclosed sensor probe is configured so as to be capable of evaluating a countersunk hole used with a flat head fastener.

20. An eddy current sensing technique for evaluating a material having a test not cold worked zone and a test hole that is surrounded by a test annular cold worked zone that has an unknown cold working effectiveness, said technique comprising:
imposing an alternating current on a probe having two sensor coils to produce two changing magnetic fields;
measuring a first reference electrical conductivity of a reference annular cold worked zone around a reference hole in a reference specimen having a known cold working effectiveness and measuring a second reference electrical conductivity of a reference not cold worked zone in a reference specimen having a known not cold working effectiveness to produce a reference differential result, said known cold working effectiveness indicating that said reference annular cold worked zone has experienced a desired amount of plastic strain;
measuring a first test electrical conductivity of the test annular cold worked zone and measuring a second test electrical conductivity in the test not cold worked test zone to produce a test differential result; and
comparing the test differential result to the reference differential result and producing a determination of whether and the extent to which the test hole has experienced said desired amount of plastic strain;
thereby assuring that said determination is not influenced by ambient temperature variation during the measuring steps, by the metal alloy composition of the material, by heat treatment of the material, by artificial aging of the material, and by rolling of the material.

21. The eddy current sensing technique of claim 20 further comprising:
imposing an alternating current on said probe having said two sensor coils comprising an evaluation sensor and a reference sensor, said two sensor coils being arranged in a side by side pattern wherein said evaluation sensor is postionable on the test annular cold worked zone while said reference sensor is positioned on the test not cold worked zone and said evaluation sensor is positionable on said reference annular cold worked zone while said reference sensor is positioned on said reference not cold worked zone.

22. The eddy current sensing technique of claim 20 further comprising:
imposing an alternating current on a probe having a plurality of sensor coils comprising an evaluation sensor and a reference sensor wherein said plurality of sensor coils is arranged in a concentric pattern wherein said evaluation sensor is positionable on the test annular cold worked zone while a reference sensor is positioned on an annular test not cold worked zone and said evaluation sensor is positionable on said reference annular cold worked zone while said reference sensor is positioned on said reference not cold worked zone.

23. The eddy current sensing technique of claim 20 wherein said alternating current is in a range between about 10 kHz and about 100 kHz.
thereby producing increasing material penetration without being influenced by the thickness of the material.

24. An eddy current sensing technique for evaluating a material having a test not cold worked zone and a test hole that is surrounded by a test annular cold worked zone that has an unknown cold working effectiveness, said technique comprising:
imposing an alternating current on a calibrated probe having a plurality of sensor coils comprising an exciting sensor, an inner evaluation sensor and a outer reference sensor that are disposed in a concentric exciting-excited arrangement wherein said inner evaluation sensor is located on the test annual cold worked zone, said outer reference sensor is located on a reference annular zone, and said exciting sensor is located between said inner evaluation sensor and said outer reference sensor;
measuring a reference electrical conductivity of said reference annular zone to produce a reference signal;
measuring a test electrical conductivity of the test annular zone to produce a test signal; and
comparing said test signal to said reference signal and producing a determination of whether and the extent to which the test hole has experienced said desired amount of plastic strain.

25. A nondestructive evaluation apparatus for determining whether a cold worked hole in an electrically conductive specimen is cold worked to an acceptable level, said nondestructive evaluation apparatus comprising:
a probe comprising an eddy current sensor that is operative to generate an eddy current in a portion of the electrically conductive specimen around the cold worked hole and not in the remainder of the electrically conductive specimen, to evaluate said portion for cold work effectiveness, and to produce an output signal; and
a detector that is operative to send an input signal to said probe, to process the output signal from said probe, to produce a result, and to communicate said result to a user.

26. The nondestructive evaluation apparatus of claim 25 wherein said probe further comprises an electronic signal conditioning circuit that comprises a resonant filter bridge in a full bridge arrangement comprising:
two passive RLC filters, wherein the resonant response of the resonant filter bridge is operative to maximize the amplitude response of said eddy current sensor and to minimize the response of said eddy current sensor to incomplete inductive coupling between said eddy current sensor and said electrically conductive specimen, and wherein said resonant filter bridge is operative to maximize the phase shifting response of said eddy current sensor to small variations of sensor probe impedance; and
two buffer amplifiers, one in each half bridge of said resonant filter bridge, which provide an input impedance to an input signal from a frequency generator located on a separate circuit board and connected to said resonant filter bridge via an interconnect cable, signal isolation between each half bridge, an amplified current for said eddy current sensor, and an output impedance that increases the Q-factor of said RLC filter and increases the sensitivity of said eddy current sensor; and
an instrument amplifier that is operative to amplify amplitude and phase shift differences between each half bridge and to combine an amplified output from each half bridge into a single differential output signal;
thereby preserving the ability the apparatus to evaluate complex impedance data, real and imaginary.

27. The nondestructive evaluation apparatus of claim 25 wherein said detector further comprises:
a resonant filter bridge circuit that comprises an eddy current sensor and an RCL filter operating near resonance and is operative to provide multiple stages of amplification of changes in sensor probe impedance and to produce amplified phase shifts in a bridge output signal, thereby taking advantage of the phase response of said RCL filter operating near resonance to amplify small inductance changes from said eddy current sensor;
an instrument amplifier that is operative to convert a phase shift to an amplitude;
a synchronous detector circuit with selective filters that are operative to tune out unwanted noise; or
a lock-in amplifier circuit that comprises a phase shifter that is operative to create a reference signal from a source frequency generator output, and lock-in amplifiers that are operative to extract reference signals and sensed signals from background noise.

28. The nondestructive evaluation apparatus of claim 25 wherein said eddy current sensor further comprises an evaluation sensor and a reference sensor and said detector further comprises:
a plurality of dummy coils; and
a resonant filter bridge circuit in a full bridge arrangement that includes a coil switching configuration that is operative to allow switching among said dummy coils that are temperature stable and provide a reference to said evaluation sensor and said reference sensor, wherein said dummy coils are switched in and out of said resonant filter bridge circuit to provide comparative data between a test measurement and a reference measurement;
thereby providing reference values during warm up of the apparatus, reference values during operation of the apparatus, and means for compensating for thermal drift in apparatus components.
